(19) United States
(12) Patent Application Publication
(10) Pub. No.: US 2007/0239469 A1
(43) Pub. Date: Oct. 11, 2007

(54) METHOD AND SYSTEM FOR FACILITATING A GOAL-ORIENTED DIALOGUE

(75) Inventors: Sara K. Minnis, Austin, TX (US); William C. Minnis, (US); John Clark, (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(73) Assignee: del Fuego Companies, Austin, TX (US)

(21) Appl. No.: 11/279,097

(22) Filed: Apr. 7, 2006

(51) Int. Cl. G06Q 10/00; G06Q 30/00

(52) U.S. Cl. 705/1

(57) ABSTRACT

The System and method and software product for facilitating a goal-oriented dialogue by determining a client's and a sales representative's motivational characteristic via a true/false questioning format, and combines the characteristics to produce an interact, present and position script for coaching the sales representative in negotiations with the client.

### RELATED APPLICATION

This application claims the benefit of U.S. Provisional Application Ser. No. 60/669,338, filed Apr. 7, 2005 under 35 U.S.C. 119(e) and incorporates by reference in its entirety all subject matter of the above described application in its entirety as if fully set forth herein.

### FIELD OF THE INVENTION

The disclosed subject matter relates to human interactions and goal-based interpersonal communications. More particularly, this disclosure relates to a novel and improved method and system for facilitating a goal-oriented dialogue such as a sales or negotiating dialogue between two or more individuals.

### DESCRIPTION OF THE RELATED ART

The holy grail of sales and sales representatives has always been the art of closing the deal. To this end, sales representatives are taught, coached, schooled and seminared to death to acquire the skills to close the deal and complete the sale. The prior art has focused on various methodologies to enhance the sales experience, such as targeted advertising, building relationships with potential buyers and self-help books, just to name a few.

Focus recently has been on data-mining and extrapolating from what a buyer has purchased in the past to what they are likely to buy in the future. While this information is relevant and provides some insight into the buyers motivations, it does not give a precise picture of who the buyer is.

The prior has also focused on the motivation behind the buying process. In real estate, the automotive industry, clothing industry and electronics industry the motivation of the buyer is often very different. What is motivation for one buyer in the same exact setting is not for another. Also, knowing that a buyer is motivated to buy or seller is motivated to sell is only half of the equation. Motivated buyers and sellers will have different styles or characteristics that, while not affecting the final outcome of whether they buy or sell something, but who they will buy or sell the something from or to, respectively.

The prior art, while recognizing that motivation is an important factor in the buying/selling process, has placed very little focus on the motivational characteristics of the buyer.

The prior is deficient in that here-to-fore it has not address the underlying characteristics of a buyer/seller that are separate and apart from the fact that they motivated to do something.

What is needed is a system and method for characterizing the client's (sell or buyer) motivational characteristics and how the motivational characteristics of the sales representative impact the selling process.

What is further needed is a method for coaching a sales person automatically regarding the motivation of both the seller and buyer and the implementation and presentation of that methodology.

### SUMMARY OF THE INVENTION

The present invention has been made in view of the above circumstances and has as an aspect a goal-oriented marketing approach.

A further aspect of the present invention is goal-oriented marketing approach based on a client's motivational characteristics.

An additional aspect of the present invention is a goal-oriented marketing approach based on the sales representative's motivational characteristics.

A still further aspect of the present invention is a goal-oriented marketing approach based on a combination of a client and sales representative motivational characteristics.

Additional aspects and advantages of the invention will be set forth in part in the description which follows, and in part will be obvious from the description, or may be learned by practice of the invention. The aspects and advantages of the invention will be realized and attained by means of the elements and combinations particularly pointed out in the appended claims.

To achieve these and other advantages and in accordance with the purpose of the present invention, as embodied and broadly described, the present invention can be characterized according to one aspect the invention comprises a method for implementing a goal oriented dialogue, the method including the steps of gathering and inputting data relating to a client's motivational characteristics and analyze and diagnosis a client's motivational characteristic. A further aspect of the present invention gathers and input data relating to a sales representative motivational characteristic and analyzes and diagnoses a sales representative motivational characteristic and combines the diagnosed client's and sales representative motivational characteristic. A goal-oriented sales strategy is then generated based on combined diagnosis and implemented by the sales representative.

It is to be understood that both the foregoing general description and the following detailed description are exemplary and explanatory only and are not restrictive of the invention, as claimed.

### BRIEF DESCRIPTIONS OF THE DRAWINGS

The accompanying drawings, which are incorporated in and constitute a part of this specification, illustrate several embodiments of the invention and together with the description, serve to explain the principles of the invention.

FIG. 1 depicts a computer system and operating environment for an aspect of the present invention.

FIG. 2 depicts a motivational characteristic matrix of an aspect of the present invention.

FIG. 3 a schematic flow chart diagram of the motivational characteristic generation for a sales representative of the present invention;

FIG. 4 a schematic flow chart diagram of the motivational characteristic generation for a client of the present invention;

FIG. 5 a schematic flow chart diagram of the motivational characteristic generation, combination and execution based on a sales representative and client's motivational characteristics.

FIG. 6 depicts an aspect of an embodiment of the present invention;

FIG. 7 depicts an aspect of an embodiment of the present invention;

FIG. 8 depicts an aspect of an embodiment of the present invention;

FIG. 9 depicts an aspect of an embodiment of the present invention;

FIG. 10 depicts an aspect of an embodiment of the present invention;

FIG. 11 depicts an aspect of an embodiment of the present invention;

FIG. 12 depicts an aspect of an embodiment of the present invention;

FIG. 13 depicts an aspect of an embodiment of the present invention;

FIG. 14 depicts an aspect of an embodiment of the present invention;

FIG. 15 depicts an aspect of an embodiment of the present invention;

FIG. 16 depicts an aspect of an embodiment of the present invention;

FIG. 17 depicts an aspect of an embodiment of the present invention;

FIG. 18 depicts an aspect of an embodiment of the present invention;

FIG. 19 depicts an aspect of an embodiment of the present invention;

FIG. 20 depicts an aspect of an embodiment of the present invention;

FIG. 21 depicts an aspect of an embodiment of the present invention;

FIG. 22 depicts an aspect of an embodiment of the present invention;

FIG. 23 depicts an aspect of an embodiment of the present invention;

FIG. 24 depicts an aspect of an embodiment of the present invention;

FIG. 25 depicts an aspect of an embodiment of the present invention;

FIG. 26 depicts an aspect of an embodiment of the present invention;

FIG. 27 depicts an aspect of an embodiment of the present invention;

FIG. 28 depicts an aspect of an embodiment of the present invention;

FIG. 29 depicts an aspect of an embodiment of the present invention;

FIG. 30 depicts an aspect of an embodiment of the present invention;

FIG. 31 depicts an aspect of an embodiment of the present invention;

FIG. 32 depicts an aspect of an embodiment of the present invention;

FIG. 33 depicts an aspect of an embodiment of the present invention;

FIG. 34 depicts an aspect of an embodiment of the present invention;

FIG. 35 depicts an aspect of an embodiment of the present invention;

FIG. 36 depicts an aspect of an embodiment of the present invention;

FIG. 37 depicts an aspect of an embodiment of the present invention;

FIG. 38 depicts an aspect of an embodiment of the present invention;

FIG. 39 depicts an aspect of an embodiment of the present invention;

FIG. 40 depicts an aspect of an embodiment of the present invention;

FIG. 41 depicts an aspect of an embodiment of the present invention;

FIG. 42 depicts an aspect of an embodiment of the present invention;

FIG. 43 depicts an aspect of an embodiment of the present invention;

FIG. 44 depicts an aspect of an embodiment of the present invention;

FIG. 45 depicts an aspect of an embodiment of the present invention;

FIG. 46 depicts an aspect of an embodiment of the present invention;

FIG. 47 depicts an aspect of an embodiment of the present invention;

FIG. 48 depicts an aspect of an embodiment of the present invention;

FIG. 49 depicts an aspect of an embodiment of the present invention;

FIG. 50 depicts an aspect of an embodiment of the present invention;

FIG. 51 depicts an aspect of an embodiment of the present invention;

FIG. 52 depicts an aspect of an embodiment of the present invention;

FIG. 53 depicts an aspect of an embodiment of the present invention;

FIG. 54 depicts an aspect of an embodiment of the present invention;

FIG. 55 depicts an aspect of an embodiment of the present invention;

FIG. 56 depicts an aspect of an embodiment of the present invention;

FIG. 57 depicts an aspect of an embodiment of the present invention;

FIG. 58 depicts an aspect of an embodiment of the present invention;

FIG. 59 depicts an aspect of an embodiment of the present invention;

FIG. 60 depicts an aspect of an embodiment of the present invention;

FIG. 61 depicts an aspect of an embodiment of the present invention;

FIG. 62 depicts an aspect of an embodiment of the present invention;

FIG. 63 depicts an aspect of an embodiment of the present invention;

FIG. 64 depicts an aspect of an embodiment of the present invention;

FIG. 65 depicts an aspect of an embodiment of the present invention;

FIG. 66 depicts an aspect of an embodiment of the present invention;

FIG. 67 depicts an aspect of an embodiment of the present invention;

FIG. 68 depicts an aspect of an embodiment of the present invention;

FIG. 69 depicts an aspect of an embodiment of the present invention; and

FIG. 71 depicts an aspect of an embodiment of the present invention.

### DESCRIPTION OF THE SPECIFIC EMBODIMENTS

Reference will now be made in detail to the present embodiments of the invention, examples of which are illustrated in the accompanying drawings. Wherever possible, the same reference numbers will be used throughout the drawings to refer to the same or like parts (elements).

In accordance with the invention, the present invention includes a method for implementing a goal oriented dialogue, the method including the steps of gathering and inputting data relating to a client's motivational characteristics and analyzes and diagnoses a client's motivational characteristic. A further aspect of the present invention gathers and input data relating to a sales representative's motivational characteristic and analyzes and diagnoses a sales representative motivational characteristic and combines the diagnosed client's and sales representative motivational characteristic. A goal-oriented sales strategy is then generated based on combined diagnosis and implemented by the sales representative.

The invention will be further clarified by the following examples, which are intended to be purely exemplary of the invention.

The present embodiment provides a sales coaching system that gives the user the information to know how to sell easily and successfully and prevent those uncomfortable moments a user may otherwise have with clients. This is a communication methodology, which allows for relationship configuration with others for goal directed communication. A first application of this material is in the sales arena and sales management. Using the present sales coaching system in the sales and other scenarios the user may (a) accelerate a goal-oriented communication or sales process; (b) understand a client; and (c) develop an account planning strategy based on how a client prefers to buy. The disclosed subject matter enables the user to know the best match for sales team members with clients.

The sales coaching system accelerates a goal-oriented communication or sales process by allowing the user to understand himself and the person with whom he is interacting. That is, the present invention includes applications in many situations wherein the user desires to perform a goal-oriented dialogue or communications process with another person or group of persons. Such a situation frequently arises during product or service sales. However, the disclosed subject matter includes application in many situations beyond a normal sales process. Nonetheless and for the sake of simplicity, the following description will relate to the sales process. The present intention, however, is not to be so limited.

The disclosed subject matter also extends to a variety of management processes in which an employer and employee may participate. The various embodiments of the innovative methodology here disclosed enable unified responses at all levels in a corporation to the customer in any context. In addition, the present invention applies to a variety of additional goal-oriented dialogue and discussion applications. These applications may include use of the disclosed subject matter in real estate scenarios and transactions, legal dispute situations, including mediation, arbitration, and litigation. Moreover, the areas of product and service marketing, many different types of educational situations and environments, and other business and management situations may present robust use of this inventive subject matter.

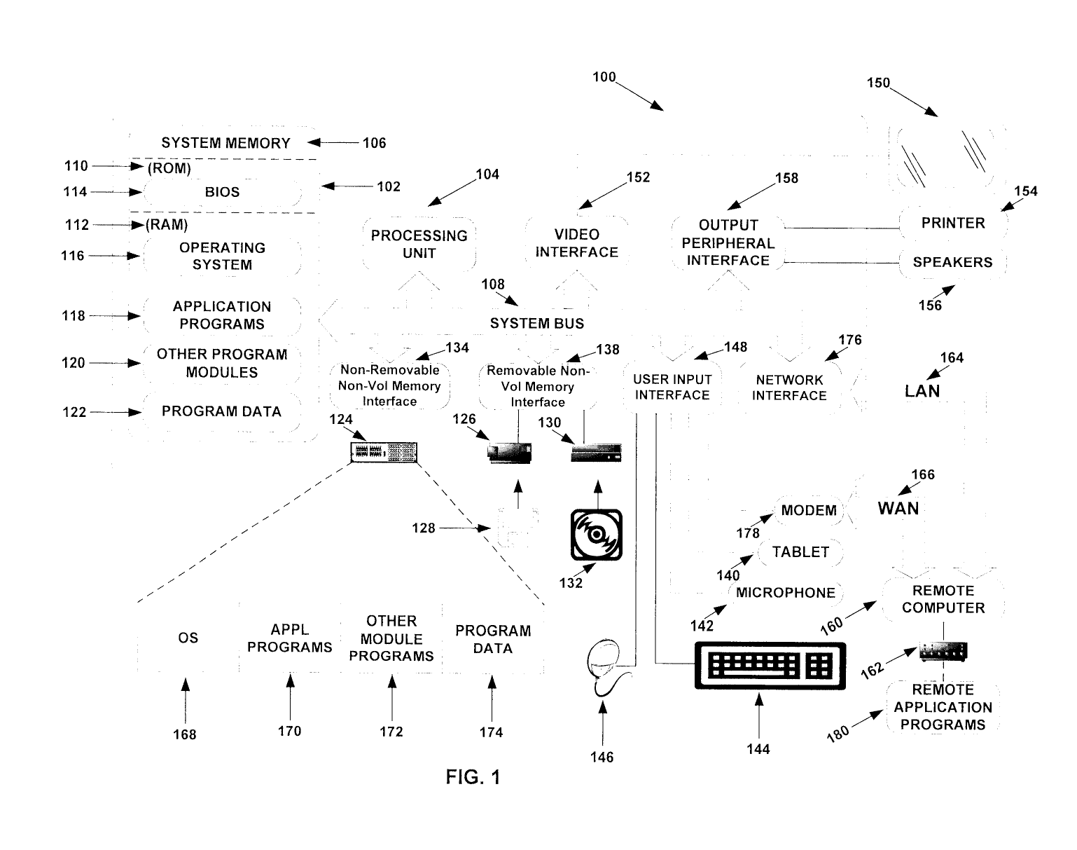

FIG. 1 is a block diagram of the hardware and operating environment 100 in which different embodiments of the present invention can be practiced. FIG. 1 provides an overview of computer hardware and a suitable computing environment in conjunction with which one or more embodiments of the present invention can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

In FIG. 1, the computing system 100 is only one example of a suitable computing environment and is not intended to suggest any limitation as to the scope of use or functionality of the invention. Neither should the computing system 100 be interpreted as having any dependency or requirement relating to any one or combination of components illustrated in the exemplary operating computing system 100.

With reference to FIG. 1, an exemplary system within a computing environment for implementing the invention includes a general purpose computing device in the form of a computing system 100, commercially available from Intel, IBM, AMD, Motorola, Cyrix and others. Components of the computing system 102 may include, but are not limited to, a processing unit 104, a system memory 106, and a system bus 136 that couples various system components including the system memory to the processing unit 104. The system bus 136 may be any of several types of bus structures including a memory bus or memory controller, a peripheral bus, and a local bus using any of a variety of bus architectures.

Computing system 100 typically includes a variety of computer readable media. Computer readable media can be any available media that can be accessed by the computing system 100 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 100.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computing system 100, such as during start-up, is typically stored in ROM 110. RAM 112 typically contains data and/or program modules that are immediately accessible to and/or presently being operated on by processing unit 104. By way of example, and not limitation, FIG. 1 illustrates operating system 116, application programs 120, other program modules 120 and program data 122.

Computing system 100 may also include other removable/non-removable, volatile/nonvolatile computer storage media. By way of example only, FIG. 1 illustrates a hard disk drive 124 that reads from or writes to non-removable, nonvolatile magnetic media, a magnetic disk drive 126 that reads from or writes to a removable, nonvolatile magnetic disk 128, and an optical disk drive 130 that reads from or writes to a removable, nonvolatile optical disk 132 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 124 is typically connected to the system bus 136 through a non-removable memory interface such as interface 134, and magnetic disk drive 126 and optical disk drive 130 are typically connected to the system bus 136 by a removable memory interface, such as interface 138.

The drives and their associated computer storage media, discussed above and illustrated in FIG. 1, provide storage of computer readable instructions, data structures, program modules and other data for the computing system 10. In FIG. 1, for example, hard disk drive 124 is illustrated as storing operating system 168, application programs 170, other program modules 172 and program data 174. Note that these components can either be the same as or different from operating system 116, application programs 120, other program modules 120, and program data 122. Operating system 168, application programs 170, other program modules 172, and program data 174 are given different numbers hereto illustrates that, at a minimum, they are different copies.

A user may enter commands and information into the computing system 100 through input devices such as a tablet, or electronic digitizer, 140, a microphone 142, a keyboard 144, and pointing device 146, commonly referred to as a mouse, trackball, or touch pad. These and other input devices are often connected to the processing unit 104 through a user input interface 148 that is coupled to the system bus 108, but may be connected by other interface and bus structures, such as a parallel port, game port or a universal serial bus (USB).

A monitor 150 or other type of display device is also connected to the system bus 108 via an interface, such as a video interface 152. The monitor 150 may also be integrated with a touch-screen panel or the like. Note that the monitor and/or touch screen panel can be physically coupled to a housing in which the computing system 100 is incorporated, such as in a tablet-type personal computer. In addition, computers such as the computing system 100 may also include other peripheral output devices such as speakers 154 and printer 156, which may be connected through an output peripheral interface 158 or the like.

Computing system 100 may operate in a networked environment using logical connections to one or more remote computers, such as a remote computing system 160. The remote computing system 160 may be a personal computer, a server, a router, a network PC, a peer device or other common network node, and typically includes many or all of the elements described above relative to the computing system 100, although only a memory storage device 162 has been illustrated in FIG. 1. The logical connections depicted in FIG. 1 include a local area network (LAN) 164 connecting through network interface 176 and a wide area network (WAN) 166 connecting via modem 178, but may also include other networks. Such networking environments are commonplace in offices, enterprise-wide computer networks, intranets and the Internet. For example, in the present embodiment, the computer system 100 may comprise the source machine from which data is being migrated, and the remote computing system 160 may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e. mirrored or stand-alone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two. Furthermore, software operations may be executed, in part or wholly, by one or more servers or a client's system, via hardware, software module or any combination of the two.

A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an ASIC.

The bus may be an optical or convention bus operating pursuant to various protocols that are well known in the art.

In the present invention it is paramount that the sales team understands what motivates the buyer, i.e. buyers motivational characteristics. The present invention quantifies key motivational patterns and provides the sales person/team with insights into the buyers motivational characteristics to enhance the goal oriented sales approach.

The present invention identifies six (6) categories that not only describes the buyer's motivational characteristics, but does so in an elegant, sophisticated approach that is simplistically employed in most every business setting. The present invention does not solely focus on the buyer's characteristics but also analyzes the sales person motivational characteristics and combines the buyer's and sales person's motivational characteristics into one cohesive strategy, while being cognizant of the strengths, differences and dynamics of the sales interaction.

The six (6) motivational characteristics are as follows:

Internals

Internals are motivated by making their own decisions.

| | |
|---|---|
| 1) | A sales person should never tell them what to do. |
| 2) | Internals should always be given the opportunity to make the |
| | decisions and ask a sales person should ask their permission to |
| | move through the sales cycle. |
| 3) | A sales person is vulnerable to power struggles between |
| | themselves and the client. |

Area of Impact: The Internal client is motivated to buy when they can decide for themselves what the next steps are in the sales cycle. This is often tricky for the sales person who has been well-trained in how to influence, persuade and question.

Without careful application of the Sales Credibility principals—influence, persuasion and questioning will alienate the Internal client. A user can review a Car Coach™ CD's (informational CD's) for Sales.

Being Credible

The internal client needs to make all the decisions themselves. The sales person/teams should do the following:

| | |
|---|---|
| 1) | Ask for their permission throughout the sales process for |
| | everything; |
| 2) | Use the language from the Key Language section and MEAN it; |
| 3) | Be prepared with facts and information, not the sales person's |
| | opinion; |
| 4) | Do not insist on doing the call your way; |
| 5) | Always give a logical reason why you want to do something, so |
| | the client can reach the same decision. |
| 6) | An example dialogue would be as follows: |
| 7) | “You know I'd love to go over what we have to offer and |
| | if we could just understand your operation first, then I could |
| | limit my discussion to what fits here. So, if I can ask you a |
| | few questions, it will make the information more relevant. Does |
| | that work for you?” |
| 8) | If the client says they'll get back to you, then use the |
| | objection handling techniques provide by the present invention |
| | Credibility Car Coach ™ CD to manage their response and get |
| | an agreed upon time. It sounds like this: “So, you'll get |
| | back to me. That's great. How about if I let you know when |
| | I'm available and we can pencil in a couple of times so you |
| | don't have to chase me down.” |

Key Language

| | |
|---|---|
| 1) | It's up to you. |
| 2) | I'll leave it with you. |
| 3) | It's your decision. |
| 4) | Does that work? |
| 5) | The decision is on your side of the table. |

Challenges

| | |
|---|---|
| 1) | The Internal client does not respond to urgency on your part. |
| 2) | The Internal client needs to be the final decision maker |
| | throughout the sales cycle. |
| 3) | If you want to close the sale with the Internal client, give |
| | them plenty of time in the closing cycle. Being aggressive |
| | will lose the sale. |
| 4) | Credibility is gained through information, not opinion. |
| 5) | In order for the Internal client to work with you, you must |
| | be perceived as credible by them. |

External Characteristics

Key Points

| | |
|---|---|
| 1) | Externals are motivated by recommendations, input and what others |
| | have done. |
| 2) | This is a great client for case studies and testimonials. |
| 3) | Never cut off contact. |
| 4) | Always give them input and recommendations throughout the |
| | sales cycle. |
| | Always keep in contact. |
| 5) | Your vulnerability: The External may change their mind depending |
| | on the last person with whom they speak. So, always be the last to |
| | present to them. |

Area of Impact

| | |
|---|---|
| 1) | The External client feels better to many sales people because the |
| | External feels more like a buyer. This is a false perception |
| | because it is related to how much the External enjoys interaction |
| | and the fact that they are motivated to find out information about |
| | what others are doing. This is why they seem to be a natural fit |
| | on the sales call. |
| 2) | Most sales people underestimate where they are in the sales cycle |
| | with the External and, as a result, lose the sale because they are |
| | not making a recommendation for action. |
| 3) | The External is most influenced by the latest information, the last |
| | person they spoke to, the last recommendation they hear. |
| 4) | To be effective and constantly in the loop with the External client, |
| | be sure you are the last person the External speaks with before they |
| | make their buying decision. |
| 5) | Review the Sales Credibility Car Coach ™ CD's for Round 1 and |
| | Round 4 for the detail on how to position your product with the |
| | External. |

Being Credible

| | |
|---|---|
| 1) | The External is motivated by interaction with you, your thoughts |
| | and ideas. |
| 2) | They are very interested in what other clients are working with |
| | you. They want references and testimonials. They are motivated by |
| | seeking input. |
| 3) | They value your opinions and recommendations. |
| 4) | They want you to tell them what you think the best course of |
| | action is. |
| 5) | Stay in touch after the sale. The External values the ongoing |
| | interaction and support. |

Key Language

| | |
|---|---|
| 1) | What others in your situation have done is . . . . |
| 2) | My recommendation for you is . . . |
| 3) | If I were you, I would . . . |
| 4) | Let me tell you several courses of action you can take. |

Challenges

The External is influenced by the last sales person they talk to, or by talking to others whose opinion they value. Be sure to be the last to present if a series of companies are presenting, and if you are not the last, then be sure to position a request to meet after all the presentations have occurred to answer any questions.

Be aware that strong Internal salespeople may find it difficult to recommend courses of action, and may not be as effective with External clients because of this.

Toward Characteristic

Key Points

| | |
|---|---|
| 1) | The Toward client is motivated by what your product or service can |
| | do that makes their company achieve better, faster, on the leading |
| | edge. |
| 2) | The Toward client is motivated to move through the sales cycle |
| | quickly. If you don't move quickly they may lose interest. |
| 3) | Never focus on the problems. |
| | Always match your product to their goals. It sounds like this: |
| 4) | With our you can leverage your goal of . |
| 5) | This product will help you achieve your target of . |
| 6) | With this, you can do faster. |

Sales representative vulnerability: If your marketing collateral talks about risk management, risk prevention, what they won't have to worry about, you are vulnerable. You are also vulnerable if you do not move the sales cycle quickly.

Area of Impact

The Toward client is influenced primarily by your ability to position you and your product in language that resonates with them. This involves linking what you do to their goals and objectives. The sales person should remember to discuss how your product helps them achieve their goal faster, leverage their opportunities into a larger market, help them make their target, and other language about the better, faster, easier solutions. The sales person marketing and sales collateral should also represent the better, faster, easier solutions. The Toward client is NOT the client with whom the sales person should discuss risk management, risk avoidance issues.

Being Credible

The Toward client is motivated by what can happen and what you can make happen. They talk in terms of their strategic vision, their goals. They are motivated by discussing how you can help them achieve their goals faster, easier. They respond to high-energy presentations, enthusiasm and activity. Refer to Round 2 Sales Credibility Car Coach™ CD for the details on how to position your product with the Toward client.

Key Language

| | |
|---|---|
| 1) | This will help you achieve . . . |
| 2) | We can make this happen. |
| 3) | This will create momentum. |
| 4) | You can have more with this. |
| 5) | Let's get going on this |
| 6) | I can make this happen for you. |

Challenges

The Toward client looses their motivation to buy if delays occur in the sales cycle and if you over promise, which happens in the enthusiasm of the sale with a strong Toward salesperson. The sales person should move quickly with demonstrations of how he can help the Toward client achieve their goals more rapidly than even they could contemplate.

Working with the Away from Client

Key Points

| | |
|---|---|
| 1) | The Away From Client is motivated by recognizing problems. |
| 2) | They actually feel energized when they find and recognize a |
| | problem. |
| 3) | Never tell them not to worry. It doesn't compute. |
| 4) | Always give full recognition to the problems and if possible, find |
| | some they haven't thought of yet. |
| 5) | Your vulnerability: They may have difficulty prioritizing, as they |
| | are most likely to deal with their most pressing problem. |

Area of Impact

Link what you do to their situation in a way that positions you and your product as helping to prevent, helping them avoid, keeping them from. Remember to discuss what your product does in terms of risk management and risk avoidance issues. Sales collateral should discuss risk management and risk avoidance issues and not discuss benefits and don't over promise. Enthusiasm is perceived by the Away From client as a red flag. They view enthusiasm as a lack of awareness of the difficulties involved. They usually feel if you need enthusiasm to sell your product, it is not a good product. The Away From client prefers a logical reason the product will keep them from having the problems they are having. Refer to Round 2 Sales Credibility Car Coach™ CD for the details on how to position your product with the Away From client.

Being Credible

| | |
|---|---|
| 1) | The Away From client needs to understand that you see the |
| | problems as clearly as they do, and you are not going to try |
| | and hide from the problems. |
| 2) | They are motivated by a discussion of what's NOT working now. |
| 3) | The Away From client always wants to know the downside and |
| | two or three back up actions they can take. |

Key Language

| | |
|---|---|
| 1) | If you'd like to prevent that . . . |
| 2) | One of the things this approach will avoid is . . . . |
| 3) | If you don't want to lose out . . . |
| 4) | In order to avoid those problems . . . |
| 5) | This approach will keep you from having those issues. |

Challenges

| | |
|---|---|
| 1) | The Away From client examines everything carefully for what won't |
| | work. |
| 2) | It can be difficult for the Away From client to take action without |
| | the sense that they can have more problems if they don't take action |
| | now. |
| 3) | Your credibility is gained through your ability to experience and |
| | discuss the problems with them. |
| 4) | The Away From client has an innate distrust of the sales person who |
| | is very Toward in their sales approach and tries to move quickly |
| | through the sales process. |

Options

Key Points

| | |
|---|---|
| 5) | The Options client is motivated by choice and variety, the ability |
| | to select from a wide range of products. |
| 6) | Never try to get them to do things one way. Never try to get them |
| | to follow your sales process. |
| 7) | Always explore with them. |
| 8) | Be prepared to offer your product in at least two or three different |
| | packages or bundling options. |
| 9) | Your Vulnerability: They will always shop around because it is |
| | motivating to them. |

Area of Impact

| | |
|---|---|
| 1) | The sales cycle with the Options client may seem somewhat chaotic |
| | and random. They usually have two or three other things going on |
| | when you are with them. |
| 2) | In the area of product or service, they are the prospect who “loves” |
| | all the features and benefits. |
| 3) | What motivates the Options client at the close is to give them more |
| | options than they have now. |
| 4) | In your proposal, present the Options client with three different |
| | ways to buy your product or service. |
| 5) | Refer to Round 2 Sales Credibility Car Coach ™ CD for the details |
| | on how to present your product to the Options client. |

Being Credible

| | |
|---|---|
| 1) | The Options client needs to be able to explore, explore, explore. |
| 2) | They will wander throughout the sales cycle. |
| 3) | They want to know if you can put together a package just for |
| | them. |
| 4) | They like to deal. For them, the give and take of negotiating is |
| | fun. |
| 5) | They keep changing the deal to stay motivated. |
| 6) | They are difficult to close because closing ends the game. |

Key Language

| | |
|---|---|
| 7) | We can do this several different ways. |
| 8) | We are extremely flexible. |
| 9) | Lets look at all the options. |
| 10) | There are many alternatives. |

My Challenges

| | |
|---|---|
| 1) | The biggest challenge with the Options client is the ongoing, |
| | seemingly endless exploration of you, your company, your product, |
| | all the different ways it could be used, the different pricing plans, |
| | and on and on. |
| 2) | Credibility is gained through your ability to be flexible, to present |
| | different ways to buy. |
| 3) | The Options client is motivated by the chase. They respond to the |
| | deal. |
| 4) | The Options client often makes large impulsive decisions to buy that |
| | even they do not understand, which is why it's worth putting up with |
| | their seemingly endless exploration. |

Procedures

Key Points

| | |
|---|---|
| 1) | The Procedures client is motivated by process and completing a |
| | process. |
| 2) | They want a plan and they want to follow it. |
| 3) | Use language that involves the number of steps: first we do this, |
| | next we do that or (a.) we do this, (b.) we do that. |
| 4) | Never call on a Procedures client without an agenda. |
| 5) | Never describe your product or service without telling them HOW |
| | it works, HOW it is delivered, HOW you will work with them. |
| 6) | Always give them a procedure to follow. |
| 7) | Always follow-up when you say you will. |
| 8) | Always work from an agenda. |

Sales reprensentative vulnerability: If your process of doing business doesn't fit with their process, you will lose the sale. Always ask the Procedures client, “How do you like to work with vendors?” “What is your standard process?” They will tell you.

Area of Impact

| | |
|---|---|
| 1) | The biggest revenue opportunity with the Procedures client is |
| | renewal. |
| 2) | This is the type of client for whom renewal seems a natural step in |
| | the process of working with you. If you position renewal as another |
| | step in your process with this client, they will renew at a much |
| | higher level than if you treat the renewal as a separate cycle. |
| 3) | Without careful application of the Sales Credibility principals - |
| | influence, persuasion and questioning will alienate the Internal |
| | client. |
| 4) | Refer to Round 2 Sales Credibility Car Coach ™ CD for the details |
| | on how to present your product to the Procedures client. |

Being Credible

The Procedures client is motivated by process and following the process. Credibility is gained by having procedures for them to follow and following them. Credibility is also gained by thorough attention to detail and follow-up. They are actually energized as they move through a sequence. The key areas for the Procedural client in any sales interaction are:

How procedural the sales person is (this is a credibility check for them), client's existing business, the sales person will close whether or not the sales person is prepared with implementation or deployment information. When the sales person is Procedural and can explain how the product is actually integrated into the sale.

Key Language

| | |
|---|---|
| 1) | Let me tell you how we work with clients. |
| 2) | Our process is . . . |
| 3) | Let me step through our product. |
| 4) | Let's go through this step by step. |

Challenges

The biggest issue with the Procedural client is being meticulous with your product. Your collateral should discuss the process, the implementation, deployment form A to Z. Your proposal should include information that covers the process, the implementation, deployment from A to Z, as well as phases of the implementation which help them see it over time. Without your attention to these areas, the Procedures client will question your credibility.

As will be discussed in detail below, a client once diagnosed will be assigned a characteristic such as ITA. ITO is defined as Internal-Towards-Procedural. The ITA designation is the shorthand code for the client or sales person motivational characteristics. In one aspect of the present invention and individual can have as many as eight (8) different motivational characteristic profiles. The are as follows:

ITP=Internal-Towards-Procedural;

ITO=Internal-Towards-Options;

IAP=Internal-Away From-Procedural;

IAO=Internal-Away From-Options;

ETP=External-Towards-Procedural;

ETO=External-Towards-Options;

EAP=External-Away From-Procedural; and

EAO=External-Away From-Options.

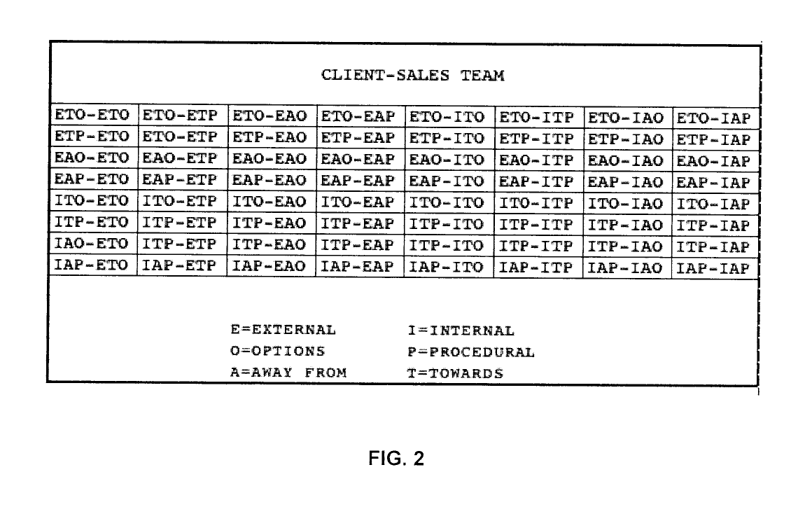

A sales representative, in one aspect of the present invention, can have as many as eight (8) motivational characteristics (same as the client). Therefore, in one embodiment of the present invention, wherein the client's and the sales person' characteristics are combined to yield a goal oriented strategy, there are 2⁶ (64) possible combinations as depicted in FIG. 2. FIG. 2 depicts an 8×8 matrix representing all of the possible (64) combinations of the client/sales person combination. The reader should note that in most cases the sales person is a sales team and generally the members of the team will not all posses the same motivational characteristics. This is also true for the client who may have several “key” members that need be consulted before closing of the deal.

The present invention contemplates the application of additional motivational characteristics beyond the eight described above. In the event that one or more characteristics are quantified in the analysis and diagnosis phases of the present invention, the total number possibilities will increase by a factor of two (i.e. 2⁷ or 128 possibilities) for each category added.

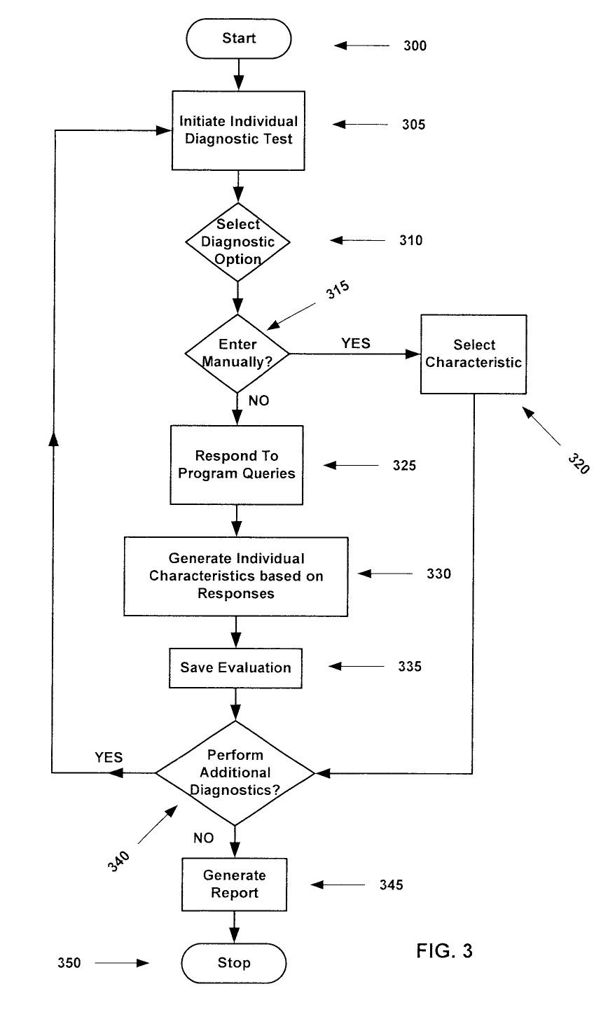

FIG. 3 depicts a flow diagram of an individual sales person diagnostic. The process is initiated by the user at step 300. After the initial setup and entering the required start-up data, the user proceeds to an initiate individual diagnostic test at step 305. The user can execute one or all of the diagnostic tests (i.e. Internal/External, Away From/Towards or Procedural/Options). At step 305 the user is prompted to initiate the diagnostic engine.

Once the diagnostic test is initiated the process flows to a selection diagnostic option 310, where the user is prompted to begin taking the evaluation.

At step 315 the user is prompted to either enter their motivational diagnostic information manually or take the diagnostic evaluation. If the user decides to enter a previous evaluation, the process proceeds to step 320. Once this step is completed the process proceeds to Perform additional diagnostic step 340, where the user is given the option to complete the evaluation.

If the user's response from step 315 is “no”, the process proceeds to respond to program queries 325. At step 325 a series of true/false formatted questions are presented and the responses captured and utilized to generate the motivation characteristics of the individual. Upon completion of step 315 the process proceeds to step 330 and generates individual motivational characteristics based on the user's responses.

The evaluation is saved at step 335. The evaluation is stored in a memory device so that it can be retrieved and later combined with the client's motivational characteristics (which will be explained below). The saved evaluation can also be utilized for comparison purposes at a later time. This is important, because over time the sales representative's characteristic or the client's characteristic may change due to a host of factors, such as but not limited to, personal issues or a new product verses an older product.

Before exiting the diagnostic engine, the user is prompted to perform additional evaluations (evaluations that have not been executed yet. Once all evaluations are completed, the process proceeds to generate report 145. At this juncture the strategy for the client is generated for use by the sales representative or sales team. The generated strategy will address how to Interaction, Position and Present to the client.

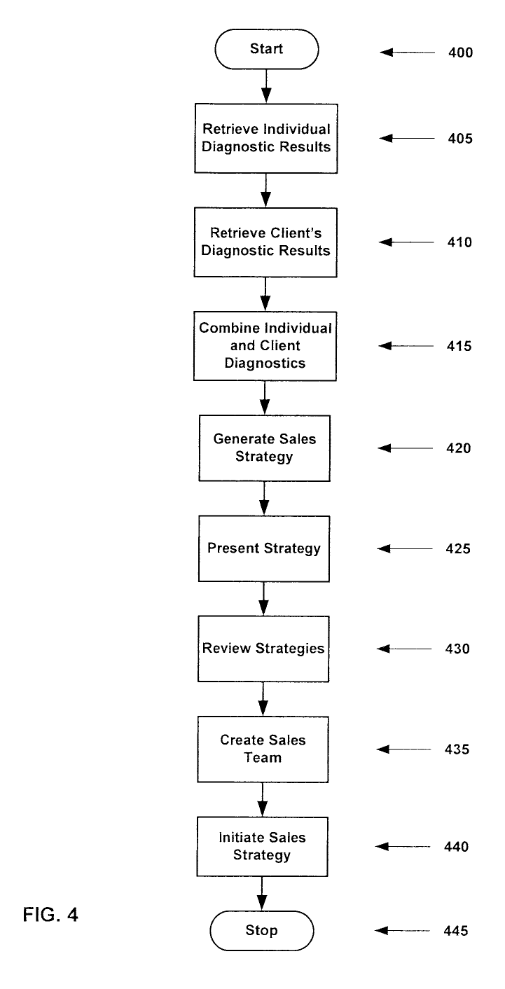

FIG. 4 depicts a flow chart diagram of the client side evaluation. The procedure described above for the individual evaluation is exactly the same, therefore, it will not be discussed at this time.

FIG. 5 depicts a flow chart diagram of an aspect of the present invention. The process begins at step 500 and then proceeds to step 505 where the individual diagnostic is retrieved 505 from memory and the client's evaluation is retrieved 510 and the evaluations are combined 315. In this embodiment of the present invention both the client and or key players in the client's company are assigned a short hand code (represent the motivation characteristic) such as IAP and the sales representative and/or team members are also assigned a short hand code (representing their motivation characteristic).

Once the process of step 515 is complete the process proceeds to step 520 where a goal-oriented marketing strategy is generated. At step 525 the strategy, along with ancillary coaching tools, are provided by the software to assist the sales representative to execute the strategy. At step 530 the strategy is reviewed and ultimately implemented. Based on the evaluations a sales team, step 535, may or may not be created to work with the client's. Once the team has been assembled at step 535 the process proceeds to step 540, where the goal-oriented strategy is implemented.

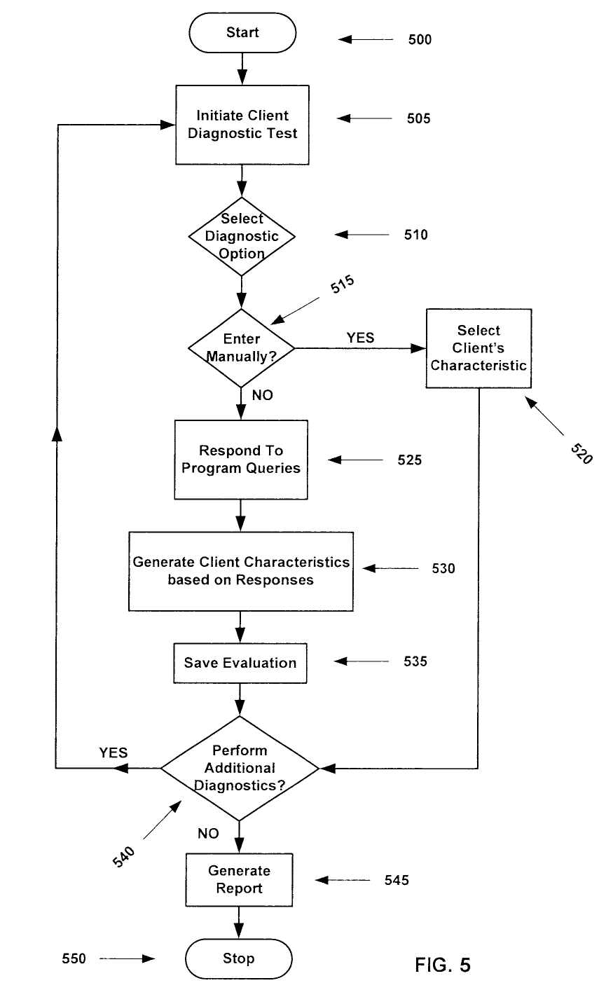

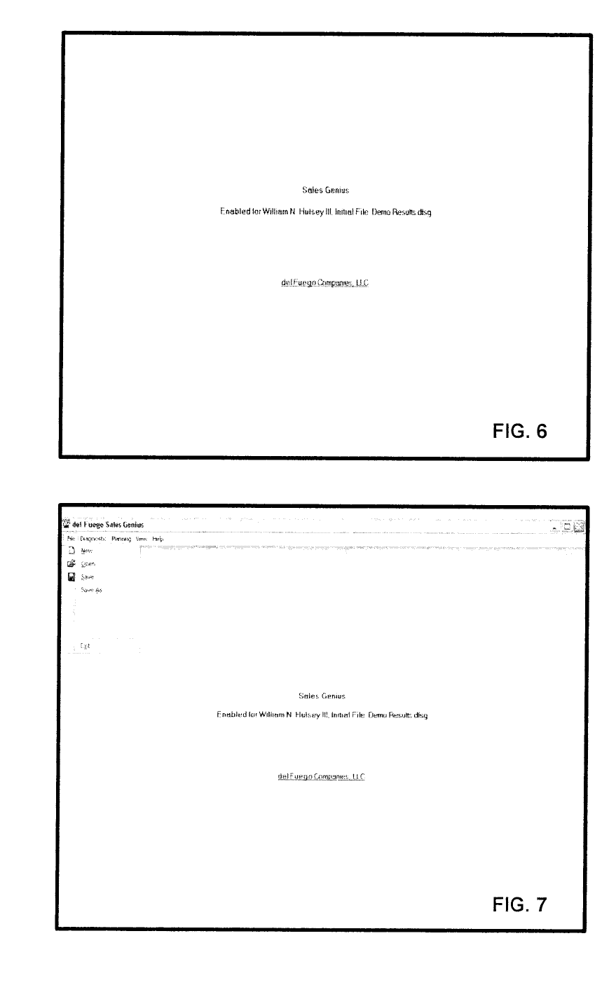

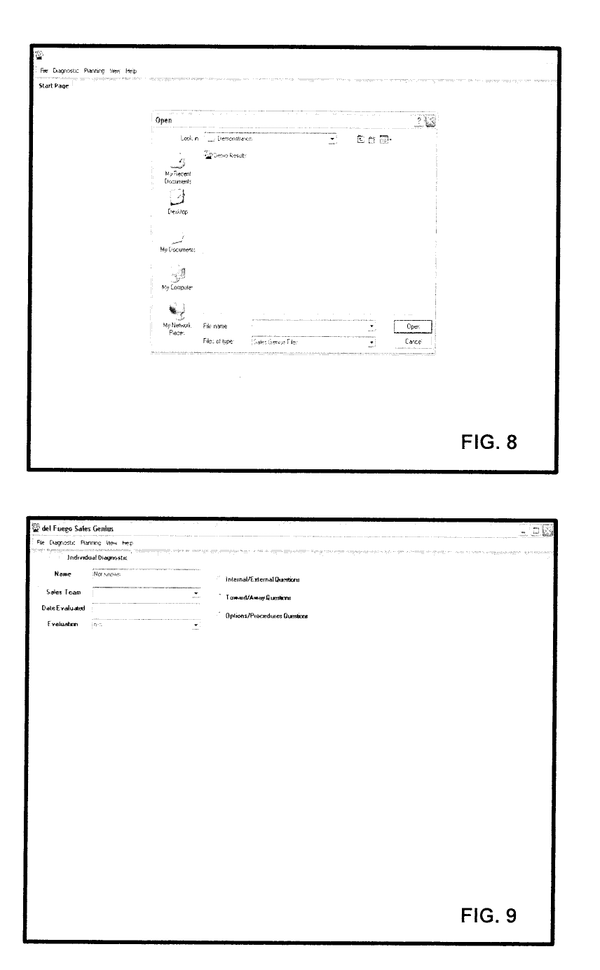

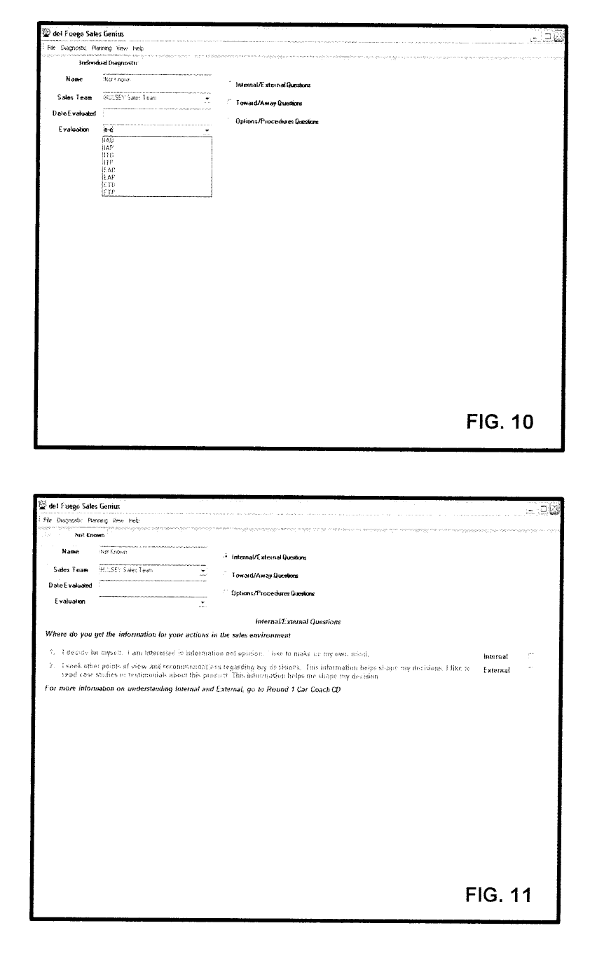

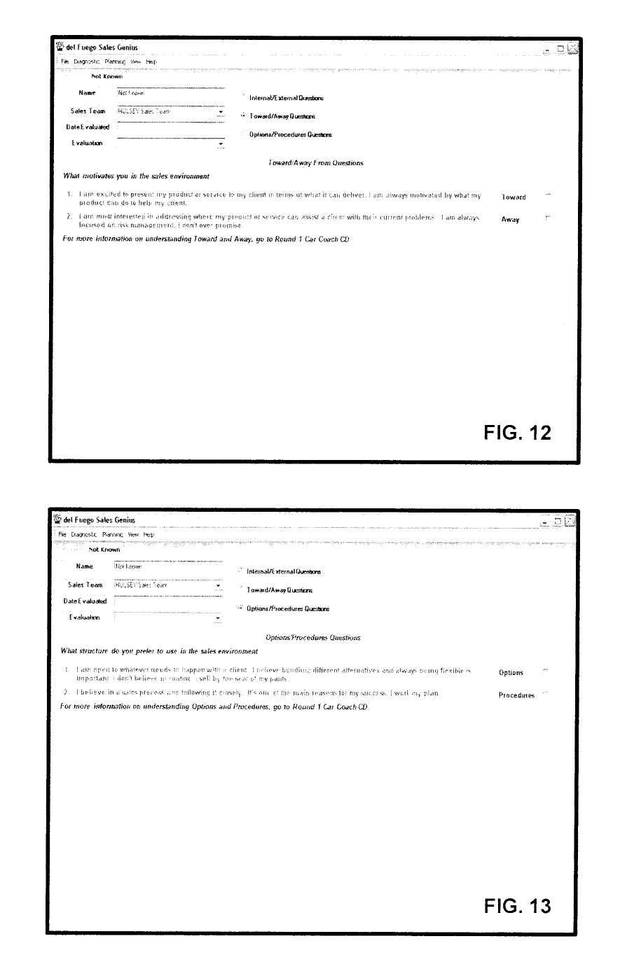

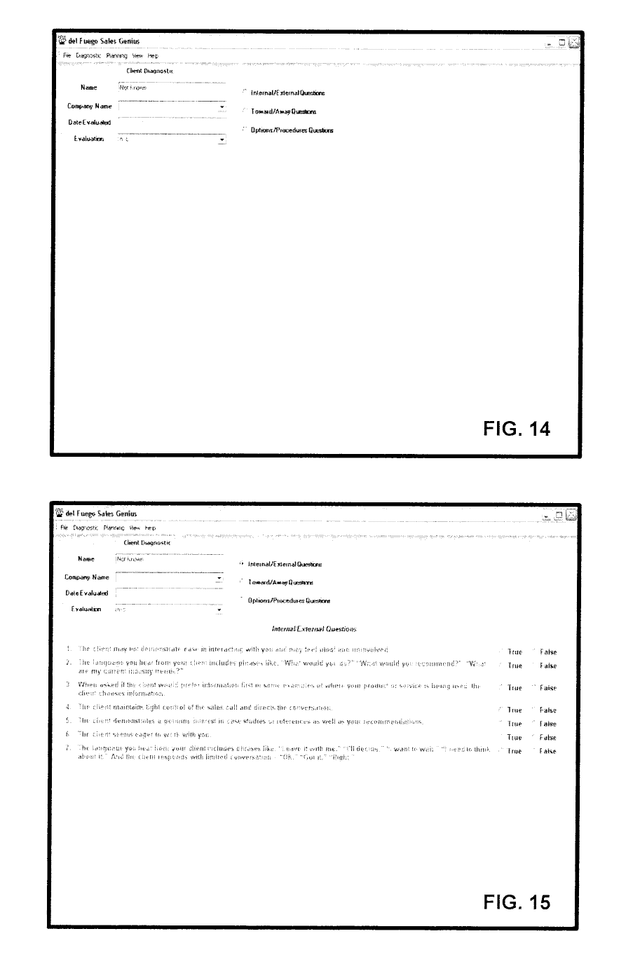

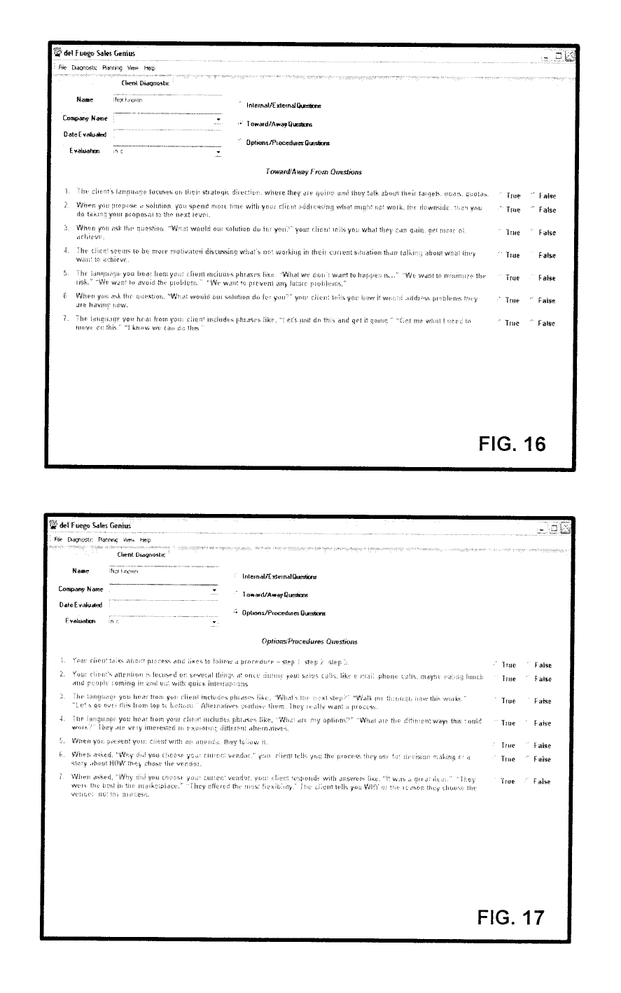

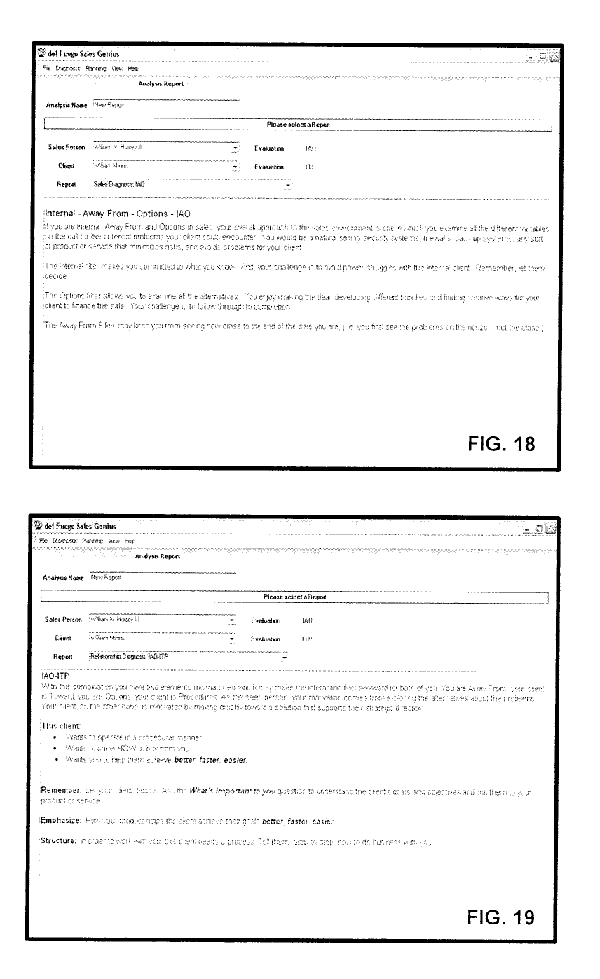

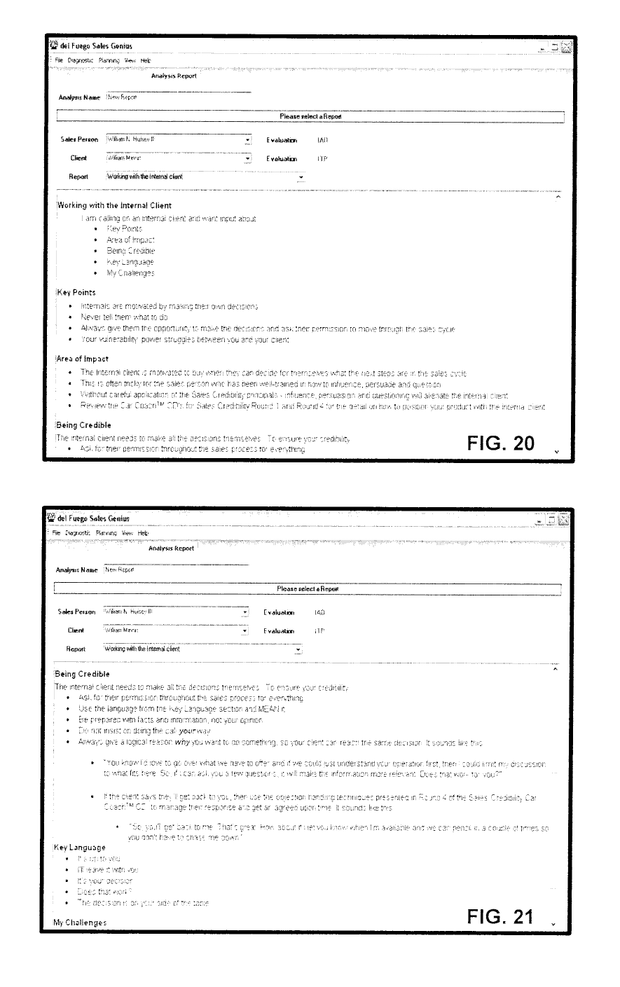

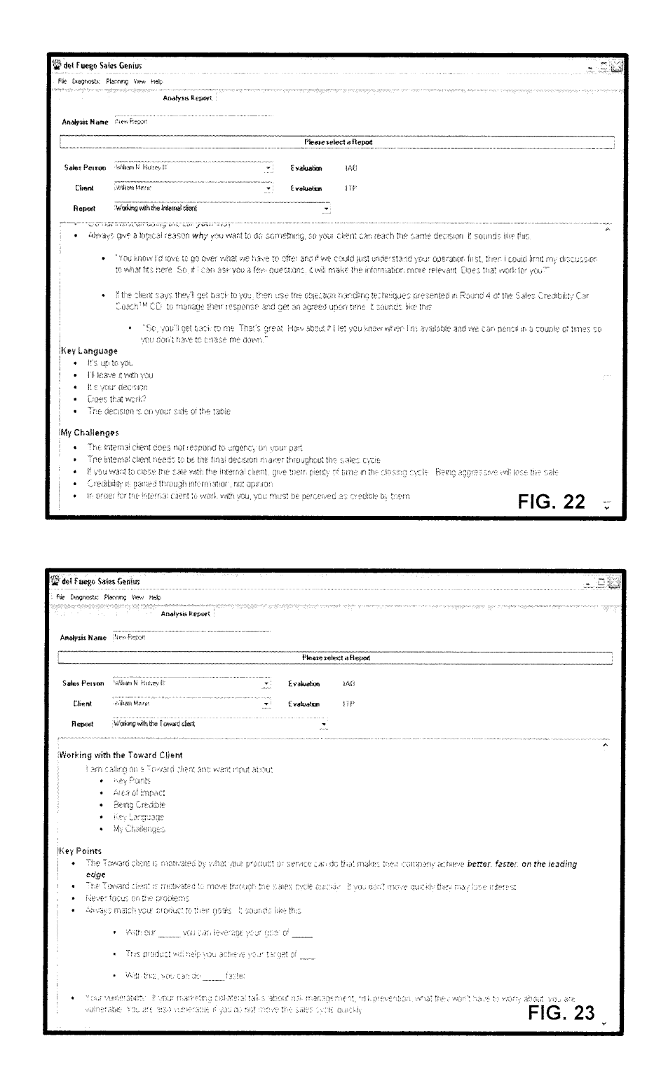

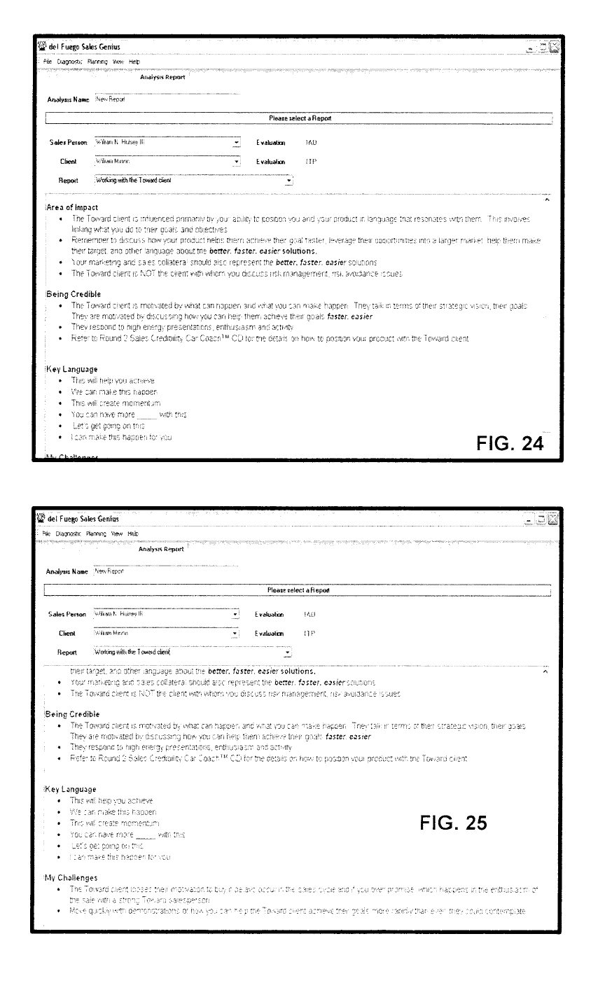

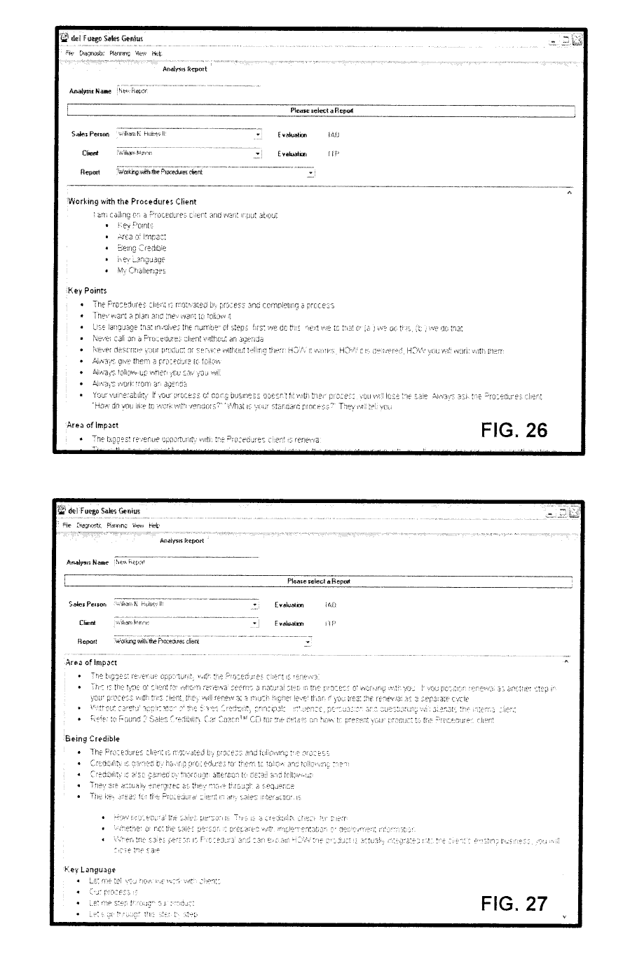

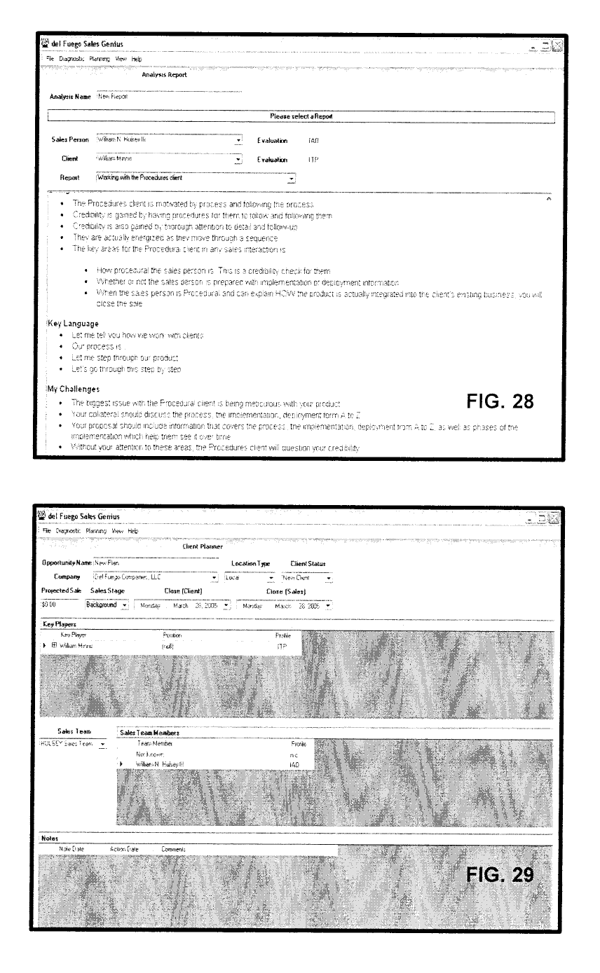

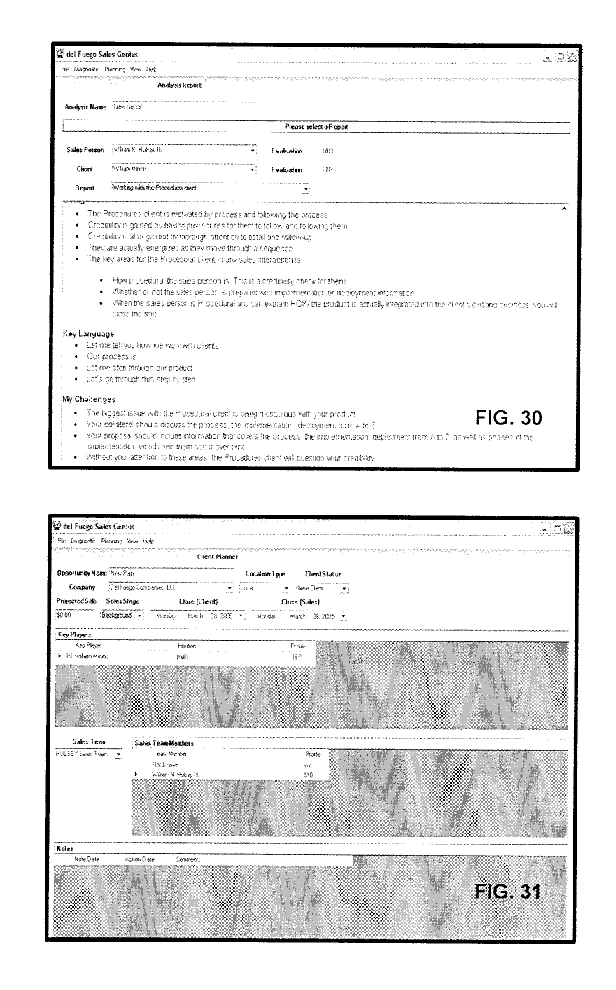

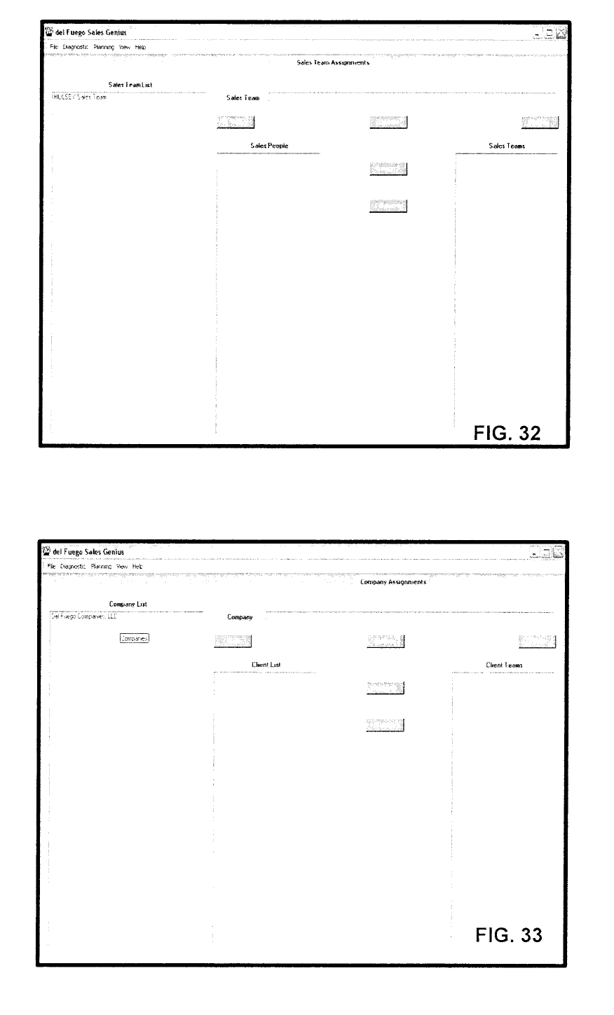

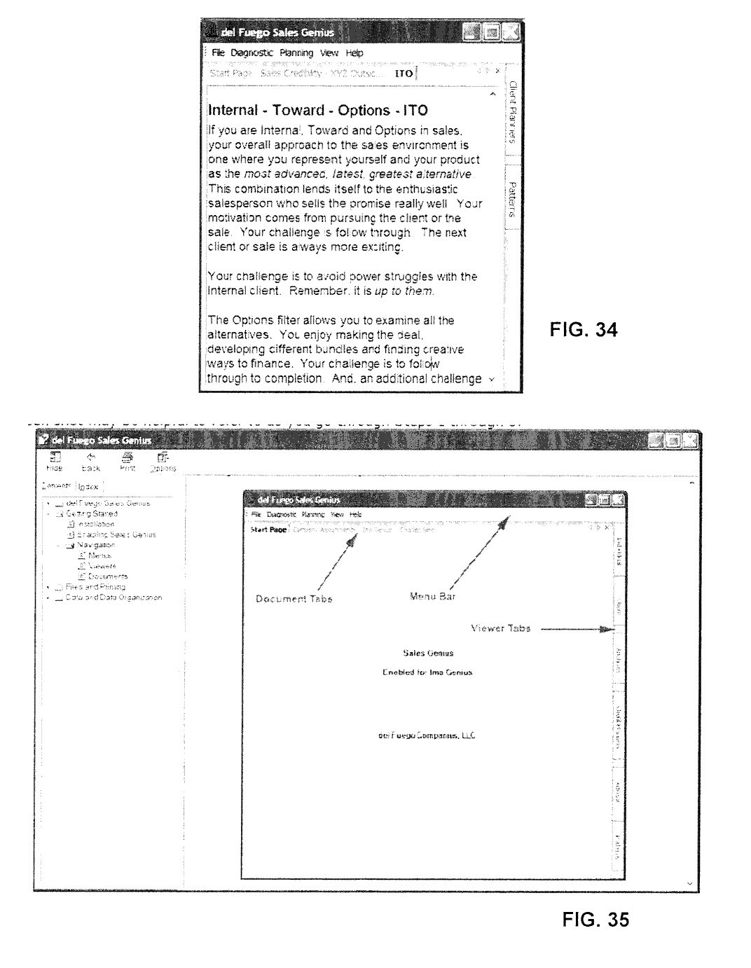

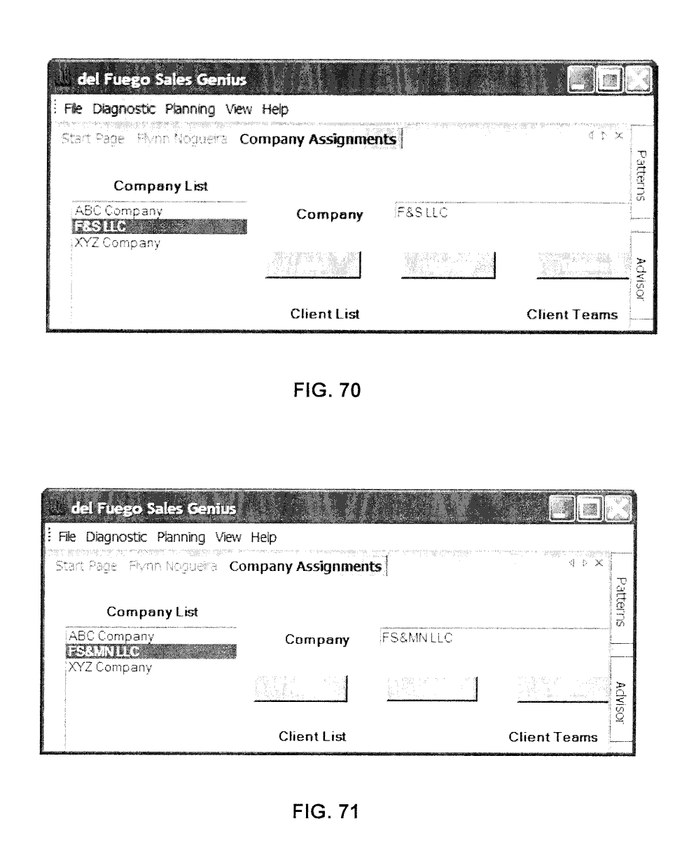

FIGS. 6 through 71 provide screen shots of the different screens appearing in the sales coaching system of the present invention. These screen shots are for illustrative purposes, as well as to demonstrate the flexibility and functionality of the disclosed subject matter. Moreover the following discussion relating to FIGS. 34 through 71 depict various exemplary operations a user may perform using the present sales coaching system. One aspect of the present invention is disclosed as being resident on a single personal computing station. A person of ordinary skill in the art will appreciate that the disclosed subject matter has application in a wide variety of technology platforms. Such technology platforms may include the use of the Internet and other on-line environments. Alternatively, personal digital assistants (PDAs), wireless handsets, and other devices may include one or more software applications, via a thin or fat client protocol, and fall within the teachings of the various aspects and embodiments of the present invention.

The present sales coaching system comprises several components and methodologies that allow the user to accelerate a goal-oriented communication or sales process immediately upon completion of training. When the user completes the individual diagnostic process, the user may apply the information to understand more about himself and a motivational pattern, i.e., a natural style. The individual diagnostic process is also an important area for identifying the motivational patterns for team members with whom the user may sell in an account. When the user and a team complete the individual diagnostic process, the group understands the chemistry in a team. In addition, this will help as the user determines who should do what within an account. To explain how to complete the individual diagnostic process, FIG. 35 shows the result of a sales person's individual diagnostic process.

To understand a client process, the user completes the client diagnostic process and applies the information to understand more about a client. This information will help the user strategize exactly how to interact, position and present to a clients.

Account planning with the sales coaching system occurs with the client planning and scheduling process. The client planning and scheduling process allows the user to develop an interactive strategy with a client in terms of how to interact, position and present in the way a client prefers to buy. With the sales coaching system, account planning may become personal. This is the step highly successful sales people may perform intuitively most of the time. And, if the user is working in a team, the user may strategize who may be the better interface with the client on a day-to-day basis. The present embodiment also shows the user how to set up a client planning and scheduling process.

Sales teams and company assignments give the user a way to easily organize sales teams and view client companies. The user knows, at a glance, which salesperson is on which sales team, who the user needs to remove and add to teams, and what a client team looks like. How to organize sales teams and view client companies is explained in below. The sales coaching system provides a shortcut to sales acceleration and customizing for every client team. Coaching the sales interaction is significantly facilitated using the present embodiment.

The present sales coaching system includes help files that the user may apply anytime to become familiar with the different features. The present process looks first at navigation, so the user understands how it works for the rest of this orientation. Then the user may complete five steps which will take the user through how to complete an individual diagnostic process, a client diagnostic process, create a client planning and scheduling process, organize sales teams, and view company assignments.

The fast start process lets the user use this tool immediately with a client from the beginning. If the user is a sales manager, the last three steps, client planning and scheduling process, organizing sales teams and viewing company assignments, will help the user manage sales associates with new information the user has not had previously.

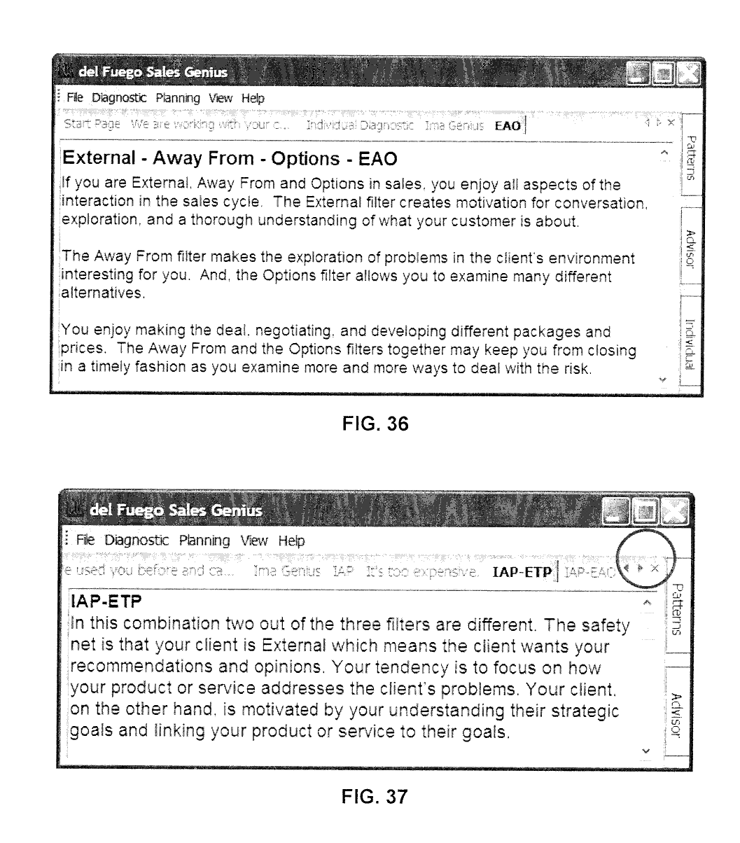

The user may want to open the present sales coaching system to complete the process initiation function in a live session. Process initiation involves reviewing navigation within the present system. There are three ways to navigate in the sales coaching system. A menu bar is located across the top of the screen. Viewer tabs are on the right hand side of the screen. Document tabs are on the top of the screen, below the menu bar. FIG. 36 shows a screen shot from the sales coaching system Help Files, which identifies each of the three navigation elements. This FIG. 36 is a screen shot of what a user may go through in the process initiation.

A menu bar is a set of “pull down” menus that allow access to all features and functions of sales coaching system including documents and viewers. The menu bar provides access to the menus functions of file, diagnostic process, planning, view, and help functions.

The viewer tabs provide a structured view of the data contained in the sales coaching system. When the user starts the sales coaching system no viewer tabs are visible. To activate a viewer tab the user may select the view menu and then the viewer the user wishes to use. The viewer tabs displayed in the above FIG. 36 are patterns, advisor, and individual.

Document tabs provide access to specific documents. Documents may be started from the menu bar or a viewer tab depending on the status and type of document the user wishes to view. The only document tab visible when the user starts the sales coaching system is the start page, which informs the user who is using the sales coaching system and which file is currently open. Each time the user opens a document in sales coaching system the name is displayed in the document tabs.

It should be note that in the FIG. 37 screen shot that the document tabs displayed are . . . used the user before and ca . . . , “Ima Genius”, IAP, It's too expensive, IAP-ETP, IAP-EAO. The document that is displayed on the screen is IAP-ETP. The user may see this, because it is highlighted in the document tab bar and the user may see it is displayed on the screen. Notice the circle on the top right-hand side of the FIG. 37 screen shot. The circle highlights two features. 1. To close a Document tab, click on the X on the top right-hand side of the screen. 2. Also, note that the sales coaching system includes a “tab scroll” to use when an open document exceed the space. The user may apply the tab scroll to move to the left and right to review what documents the user has displayed.

Here are a few helpful hints for the user for beginning to use the present sales coaching system. It is preferred that the user enter a name or the client's name when completing an individual or client diagnostic process. If the user does not, the entry will be labeled as “unknown.” In addition, it is preferable to tab to the next field for all navigation in the sales coaching system.

The present embodiment provides five basic steps to start using the sales coaching system. The user is to (1) diagnose a selling pattern; (2) diagnose a client's buying patterns; (3) create a client planning and scheduling process so the user may apply the process to an account planning process; (4) learn how to organize sales teams based on which team members are the best match for clients; and (5) learn how to view, at a glance, the key players in a client company.

The first step of diagnosing a selling pattern involves performing an individual diagnostic process. This process involves selecting a diagnostic process from the menu bar and then selecting an individual diagnostic process. From the individual diagnostic process screen, the next step is to fill in a name and the name of a sales team.

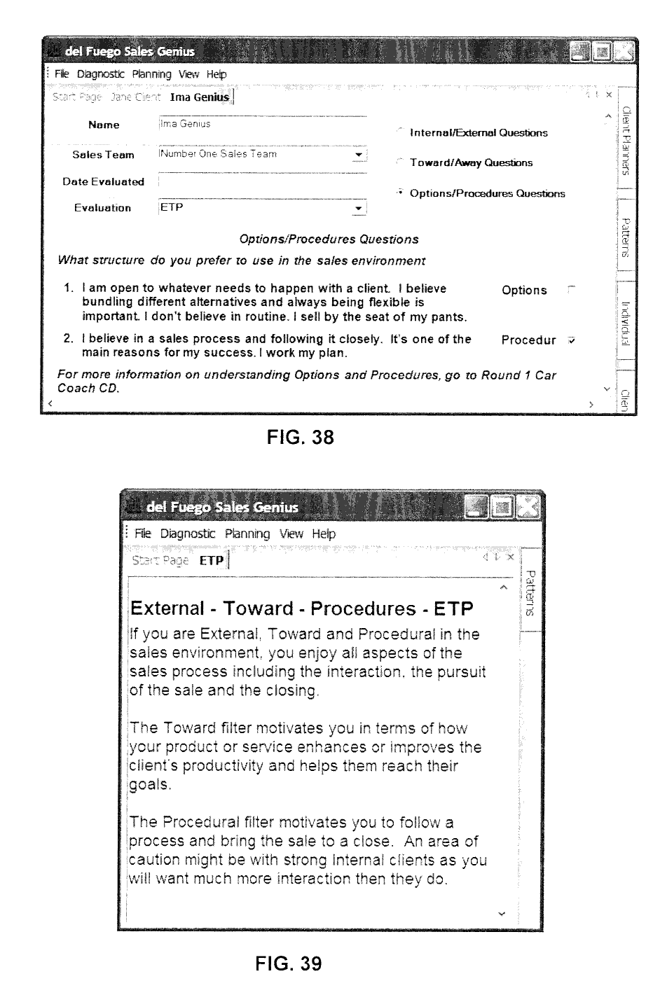

The user then clicks on an Internal/External function to the right of a name and answers the question that describes the user in the sales environment. When the user selects an answer, the question goes from red to black. The user may then complete the other two sections in the same manner: Toward/Away From and Options/Procedures. FIG. 38 provides a screen shot of the results of exemplary “Ima Genius” individual diagnostic process. Ima is ETP—External-Toward-Options. Notice the name of the sales team and the last set of questions, for Options/Procedures, are displayed.

Once the user completes the three sections, a selling pattern is displayed in the evaluation box. This involves answering the question “What does my selling pattern mean?” To find out, click on the view function on the menu bar and then click on the pattern reference function. Notice that a pattern function appears on the viewer tabs—on the right hand side of the screen. Hold a cursor over patterns and the list of patterns appears. For example, “Ima Genius” is ETP.

FIG. 39 provides a screen shot that identifies what Ima's ETP selling pattern means in the sales environment. If the user does not want to do the diagnostic process, the user may just enter my pattern manually. The user may also manually enter a selling pattern and a client's buying pattern without going through the diagnostic process. The user may use the manual method when the user believes the user knows a selling pattern and a client's buying pattern. When the user applies the manual method, he does not type in a pattern. Instead, the user may select it and tab out to the next field. Note that when the user enters the pattern manually, it is displayed in a red or other distinguishing color.

To determine a personal pattern, reference is made to the audio publication, Sales Credibility: The Missing Link in Sales, by del Fuego Publishing (ISBN: 0-9759557-5-6) (hereinafter Sales Credibility), which demonstrates how these patterns show up in any sales situation and in real life situations for that matter, and how to handle them.

The user may enter additional sales people with whom the user works to diagnose the people who are on a team and who work with a client. Once their selling pattern is in the sales coaching system, the user will have the complete set of information to develop a client strategy using the sales coaching system client planning and scheduling process.

If the user needs to change a diagnostic process, the user may change any diagnostic process, individual or client. Moreover, the user may do so manually or by going back through the questions.

To change an individual diagnostic process manually, the user may select a view function on the menu bar and then select individual diagnostic processes. Notice that an individual function appears on the viewer tabs. By holding a cursor over individual, the user may see the names of the individuals the user has diagnosed. By clicking on the name the user wants, the results appear on the screen. To change the pattern, the user may click on the down arrow in the evaluation box, select the new pattern, and tab out.

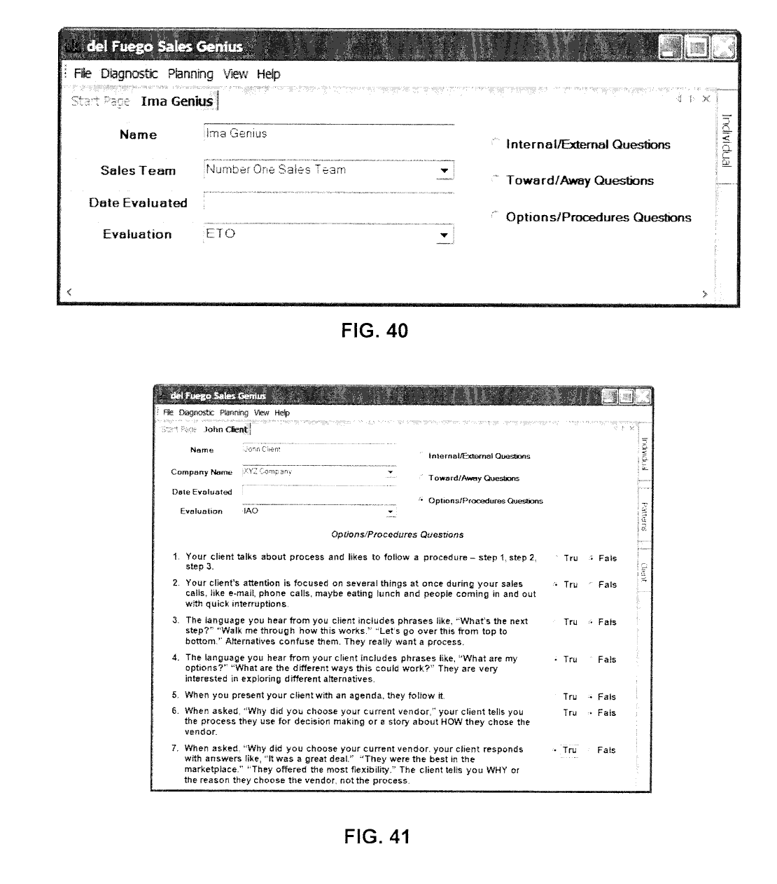

In FIG. 40 appears a screen shot of a pattern changed from ETP to ETO. The user knows it was changed manually because it is now displayed in a a red or other distinguishing color. To change the pattern using the question method, the user may select the name the user want to change, using the same process described above, and then simply click on the set of questions the user want to review/change.

Note that in FIG. 40, the start page function and ““Ima Genius”” are the two displayed document tabs. ““Ima Genius”” is the document displayed on the screen and the patterns function is displayed on the viewer tabs.

The next step involves diagnosing a client's buying pattern. This step involves thinking of one client with whom the user may be working today and using that client to complete a first client diagnostic process.

To perform the client diagnostic process, select the diagnostic process from the menu bar and then client diagnostic process. From the client diagnostic process screen, the user may fill in a client's name and the client's company name. Then, the user may click on the “Internal/External” button to the right of a client's name and answer the questions that describe a client in the sales environment. When the user selects an answer, the user may notices the question changing from red, for example, to black, or other non-distinguishing color. The user may complete the other two sections, Toward/Away From, Options/Procedures, in the same manner.

Once the user completes the three sections, a client's buying pattern is displayed in the evaluation box. FIG. 41 provides a screen shot of a completed client diagnostic process with the last set of questions, Options/Procedures, appearing on the screen for the client. Notice the client's, John's, buying pattern is IAO.

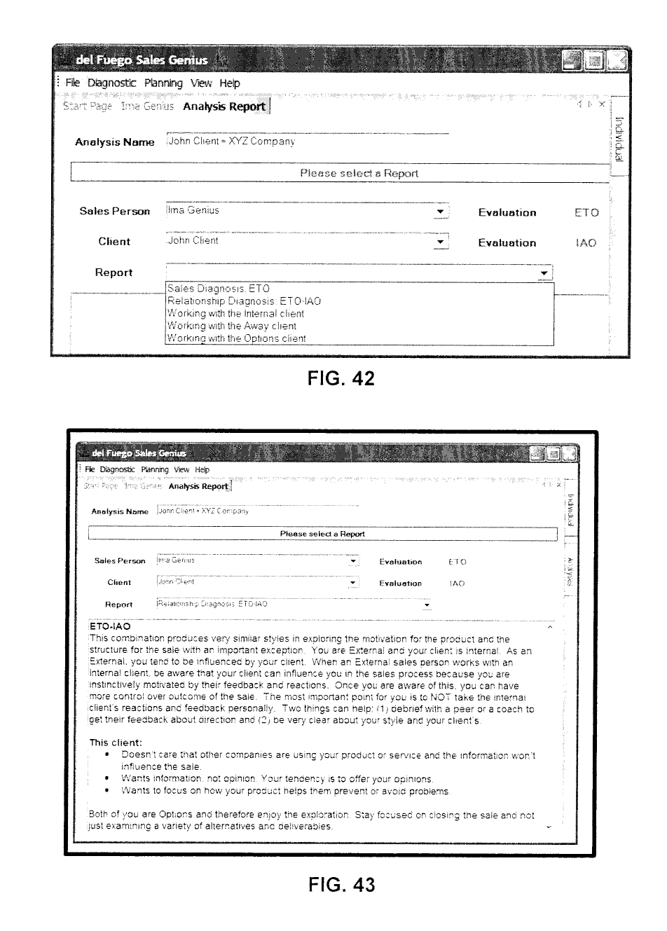

The diagnostic process analysis gives the user the ability to analyze a client sales relationship from several different aspects. FIG. 42 provides a screen shot of the different aspects the user may review. These include what a selling pattern means, what a selling pattern and a client buying pattern means in the client-sales relationship, and, then, an in-depth look at each of a client's buying patterns along with coaching prompts on how to interact, position and Present, based on the pattern.

With the diagnostic process analysis, the user may name the set of information in the present sales coaching system that is specific to the user and each client. The benefit is that the user has a convenient way to refer to the multiple aspects in different client-sales relationships. Reviewing each of these reports gives the user the competitive edge and the information to know how to build a relationship with a client in which the client views the user as credible.

Accessing the diagnostic process analysis involves selecting the diagnostic process from the menu bar and clicking on diagnostic process analysis. The user names a report, so the user may refer to them easily. Preferably, the user may give the report the name of the client followed by the name of the client's company. The user may then tab down to the sales person box and select the name the user want. The user then does the same for the client box. Then, the user tabs to the report box and clicks on the down arrow to select which report the user want.

To view the report just named, the user clicks on the view tab on the menu bar and then selects diagnostic process analysis. Notice that in the sales coaching system, Analysis appears on the viewer tabs. The user holds a cursor over analysis tab and selects the report the user wish to view.

The report in the FIG. 43 screen shot is for John client-“XYZ” company. The information displayed on the screen is the result of the relationship diagnosis. Relationship diagnosis describes the effect the sales person's and client's patterns have on the client-sales relationship. Notice the sales person is “Ima Genius” and the client is John client.

The information from the relationship diagnosis allows the user to think about primary areas the user needs to be aware of in the client-sales relationship in order to be viewed by the client as credible. The other piece of information the user has access to through diagnosis analysis includes the sales diagnosis, which explains what a selling pattern means. This is the same report as the user accessed in the pattern reference. The last three pieces of information are always specific to the client's buying pattern.

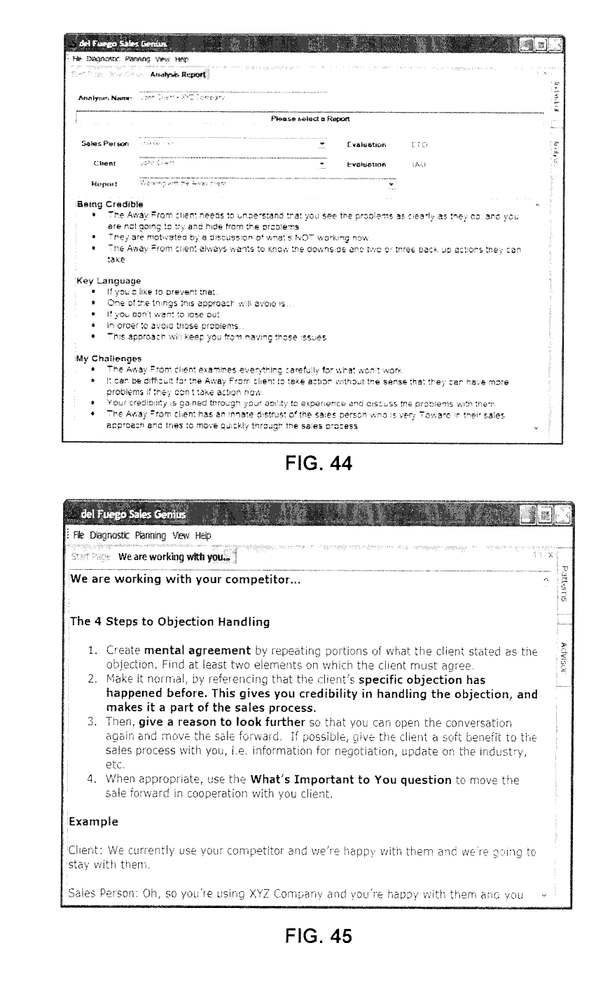

For example, in this case, the client is IAO so the three pieces of information that the user may access includes (1) working with the Internal client, (2) working with the Away From client; (3) and Working with the Options client. These reports coach the sales person on the five key areas to be aware of in working with any client. FIG. 44 shows the information in three of the five areas in the Working with the Away From client functions of the present embodiment.

The user may also access this information directly from sales coaching system Advisor:

Select the view function on the menu bar;

Click on the sales coaching system advisor function;

Hold a cursor over the advisor function on the viewer tabs;

Select the coaching prompts function from the advisor list and then select the report the user wants.

The sales coaching system advisor coaches the user in three different areas. A user may have just looked at the first one, i.e., coaching prompts. In addition to coaching prompts, the user may access information on how to handle five standard objectives using the standard objections function. The user may access information on how to create letters, proposals and presentations that address client buying patterns using the communication templates function.

FIG. 45 shows part of the information from sales coaching system advisor standard objections function. With regard to objection handling, Sales Credibility discusses in detail, with many different examples, how to handle objections.

In summary, the present embodiment provides a way to determine a selling pattern based on the results of an individual diagnostic process. This includes what the user learned about a pattern (from the pattern reference or sales diagnosis functions) that is new or different. The user may determine a client's buying pattern based on the results of the client diagnostic process the user completed. The user may also learn from the relationship diagnosis of a selling pattern and a client buying pattern.

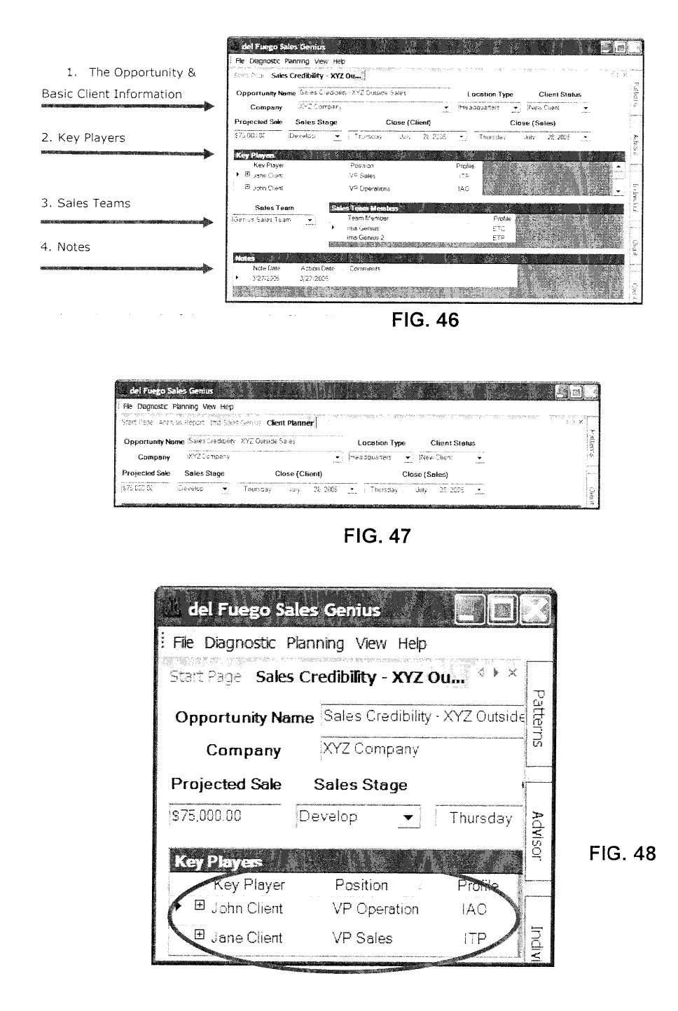

From the above, the user has the ability to click one of the coaching reports, for example, a report for working with the Internal client, that corresponds to a client buying pattern and identify one thing the user realizes the user could begin doing immediately to be more credible with this client. With regard to navigation, FIG. 46 shows two viewer tabs and two document tabs.

The additional functions of the sales coaching system allow the user to increase a strategic account planning skills. The present embodiment allows the user to develop a strategy with the client planning and scheduling process.

Application of the sales coaching system includes the operations from diagnosing a selling pattern and a client's buying pattern to the client planning and scheduling process. This part of sales coaching system lets teams work together and allows the user to teach anyone on a sales team about a client in minutes. The client planning and scheduling process aids in sales planning an interaction with the client, and having everyone on the same page.

In the present embodiment, the user preferably shall have completed the individual diagnostic process (for the sales people) and client diagnostic processes for each of the opportunities in order to use the client planning and scheduling process.

To create a new client planning and scheduling process, the user may select planning on the menu bar and then click on client planning and scheduling process. This involves first looking at the client planning and scheduling process screen. It includes four different areas: (1) the top area, which relates to a particular sales opportunity and provides some basic client information; (2) a section for key players; (3) the use of a section that deals with sales teams; and (4) a last section for Notes.

The opportunity and basic client information section of FIG. 46 shows the top part of client planning and scheduling process. This section asks for the standard information the user may gather about any potential client.

Turning to FIG. 47 in more detail, the information input includes providing the name of an opportunity. A good way to do this is to tie the product or service the user is selling to the division in the client company. For example, for the del Fuego Company, the sales coaching system enters Sales Credibility Series—“XYZ” Outside Sales. Next, the user may tab to the company. If the user already entered a client's company name, when the user completed the client diagnostic process, the name is already there. So, just click on the down arrow and select it. For the del Fuego example, the disclosed subject matter would select “XYZ” company.

Now, when the user tabs to the Location box, if the user has completed any client diagnostic processes for this company, the names of the key players appear with their patterns in the key players section. Next, the process calls for clicking on the down arrow and selecting the client location (i.e., headquarters, regional or local office). This information is valuable in terms of the level of client contact the user and a team have. This means the more the user uses this tool, the more it works for the user.

The process further calls for the user to tab to the next set of boxes and complete the information requested, i.e., use the client status function, (select one from the drop down menu) and projected sale function. This is the result of a client preparation. The last two boxes are the projected close dates—one for the client and one for a projected close. They may not always be the same. This is an important area for sales managers to review and understand, if they are different.

When the user completes a client diagnostic process on a client, the name and buying pattern, profile, appear in the key players area. The user may work with the information in this section as follows. In FIG. 48, notice the disclosed subject matter includes a completed client diagnostic processes on two key players in this account: John client and Jane client. The user clicks in the position box, to the right of the key players name and enters a client's title. Notice their profile is to the right of their title. In our example, John client is the VP of Operation and his Profile is IAO.

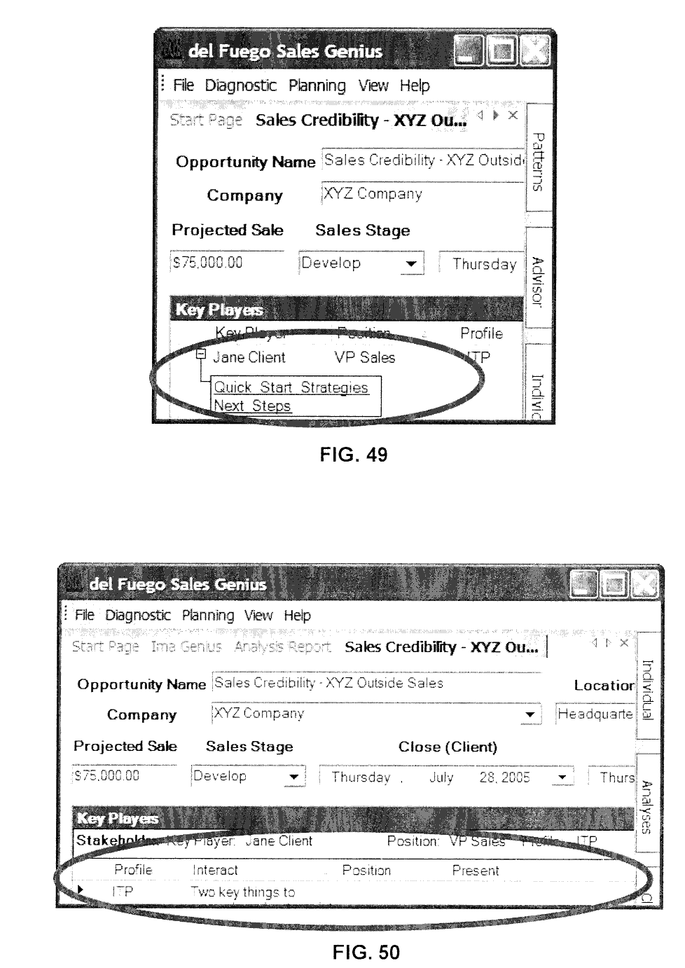

Process initiation strategies function allows the user to click on the “+” sign to the left of the key player name so that the user may see two choices, as displayed in FIG. 49. Notice the disclosed subject matter clicked the + sign next to Jane client's name.

The process initiation strategies function allows the user to identify the behaviors the user may use to create credibility in the sales interaction with the client. The skill set for using the process initiation function effectively is presented in Sales Credibility. The credibility conversation found in Sales Credibility may be applied to develop a process initiation strategies function. When the user clicks on the process initiation function, three boxes appear to the right of the client's profile, namely, (1) interact, (2) position, and (3) present. To enter information into the interact, position and present boxes, the user may simply click in the box, as shown in FIG. 50.

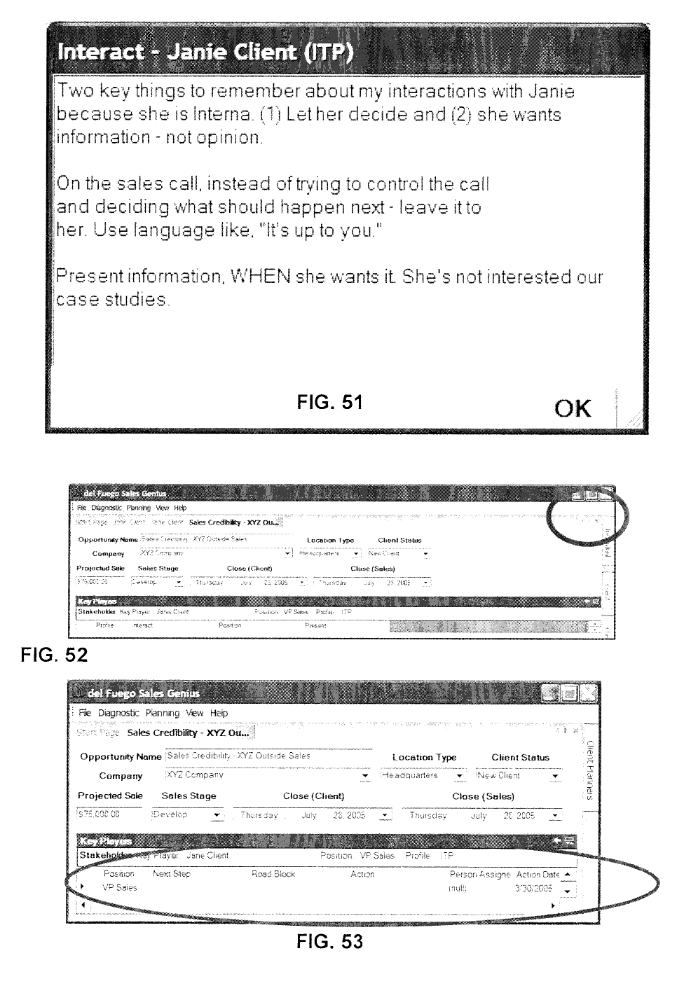

When the user clicks on the interact, position, and present boxes, a pop-up text editor appears, as in the example of FIG. 51. When the user first sees it, the pop-up text editor appears blank. The user may review the information that is relevant to the client and enter what is important at this step. When the user is finished, he may simply click “OK” to close the editor. The user may also refer to the sales coaching system advisor for more information on how to interact, position and Present to a client, given the client's buying pattern. Critical information also comes from the relationship diagnostic analysis report the user developed above.

The information the user gained from the sales coaching system advisor and the relationship diagnostic replicates sitting with a seasoned sales coach. Once the user enters information in each process initiation strategies box, the user may return to the name of the key player by clicking on the left arrow, located in the upper right hand corner of key player panel, as shown in the FIG. 52 screen shot. When the user holds a cursor over the arrow, the user may see the message—“Navigate back to parent row.” This means it will take the user back to where the user started.

When the user returns to where the user started, click on next steps. This area allows the user to identify the steps the user thinks he should take with the particular client, based on where the user is in the goal-oriented communication or sales process, their buying pattern and a selling pattern. Sales managers and team Leaders, this is a critical area to review and one in which the user may document accountability.

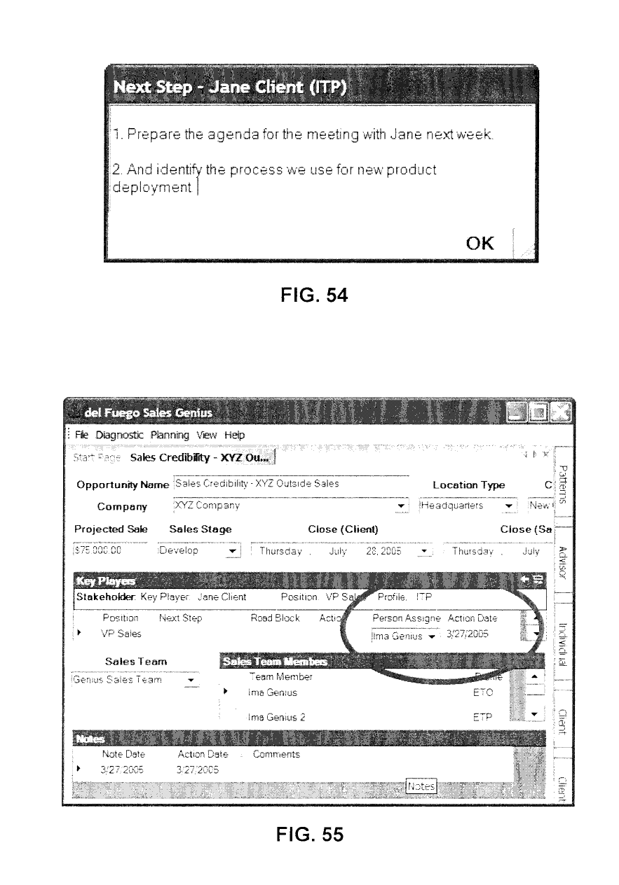

FIG. 54 shows the five different boxes in the next steps section. The next steps box identifies the next step the user thinks the user need to take with the client. The roadblocks box identifies any roadblocks the user anticipates or the user is encountering. The action box identifies the action the user may take to overcome the roadblock. The person assigned box identifies the sales person assigned to the action item. Moreover, the action date box identifies the date the action item is completed.

To enter information in the next step, roadblock and action boxes, the user may simply click in the box and the user notice a pop-up text editor appears. The user may enter the relevant information and then click OK. Notice in the next step box of FIG. 53, the disclosed subject matter has identified the next steps that address Janie's Procedural pattern.

The first time the user accesses next steps for any client, the person assigned box says “Null.” Then, the user may click on the box and a down arrow appears. When the user clicks on the arrow, the names of the sales people who are in sales coaching system, via the individual diagnostic process, appear. The user may simply select the person assigned to this action item. For this example, FIG. 55 shows that the disclosed subject matter has assigned “Ima Genius” to the action item. If the user is a sales person, the user may also have tech support and customer support people on a team who also interact with the client. If the user has completed an individual diagnostic process on them, their names will appear as well.

In the sales team assignments function, the present process looks at how the user may assign specific people to client accounts. Also note, in that FIG. 55 is a screen shot of the action date box, which is a calendar. When the user clicks in the action date box, the calendar appears and the user may assign the date when the action should be completed. In addition, for easy reference, the client's name, position and buying pattern or profile, are always present above the next steps and process initiation strategies function boxes.

The present embodiment facilitates knowing a client's buying pattern, a selling pattern and using process initiation strategies. Also, the next steps function creates the difference in how the user usually goes about account planning. With the sales coaching system, account planning will change to a very specific strategy that will tell the user how to conduct discussions with a client for the most success. Additionally, this aspect of client planning and scheduling process is an easy way to get the entire team on the same page at the same time.

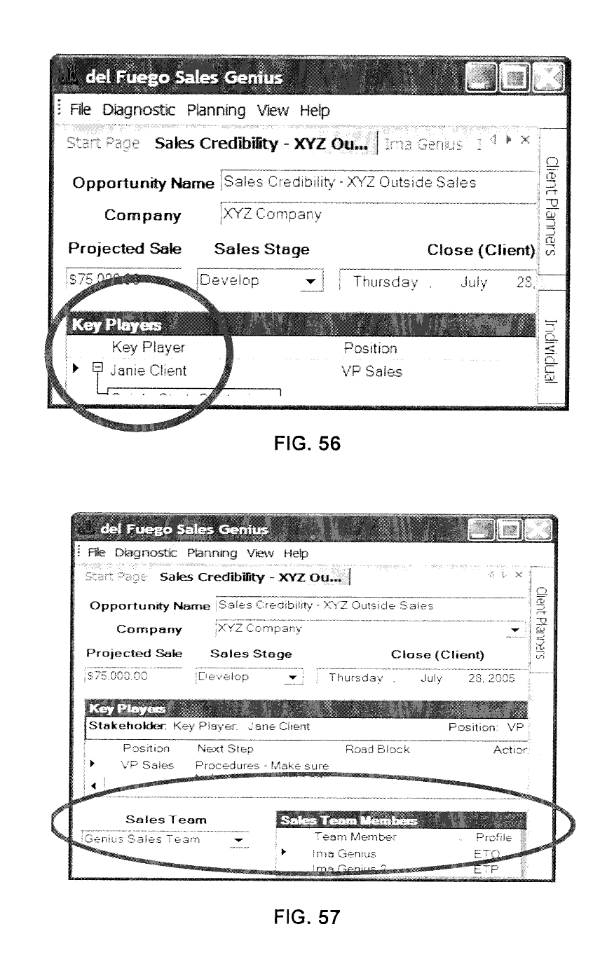

The key player section also allows the user to select the arrow in the upper right hand corner of the key player panel, as the user did before with process initiation strategies and then click on the minus box to the left of the key player name shown in FIG. 56 to close out process initiation strategies and next steps sections.

The sales team section in the client planning and scheduling process allows the user to strategize the relationships of the sales team and the relationships of the team with the account. The benefit is increased productivity within the team and a mapping strategy with multiple players within an account.

The user may identify sales teams two ways. That is, the user may complete identify sales teams through the individual diagnostic processes, as well as in the sales team assignments section. FIG. 57 provides a screen shot depicting how the present embodiment allows the user to select the sales team working with this client. This may be done by clicking on the down arrow and select the name of the team assigned to this account. In the example, once selected, the user may tab out to display the names of the people on that team. For example, “Ima Genius” and “Ima Genius 2” have been identified as part of the “Genius” sales team from their individual diagnostic process. And notice their selling pattern appears to the right of their names.

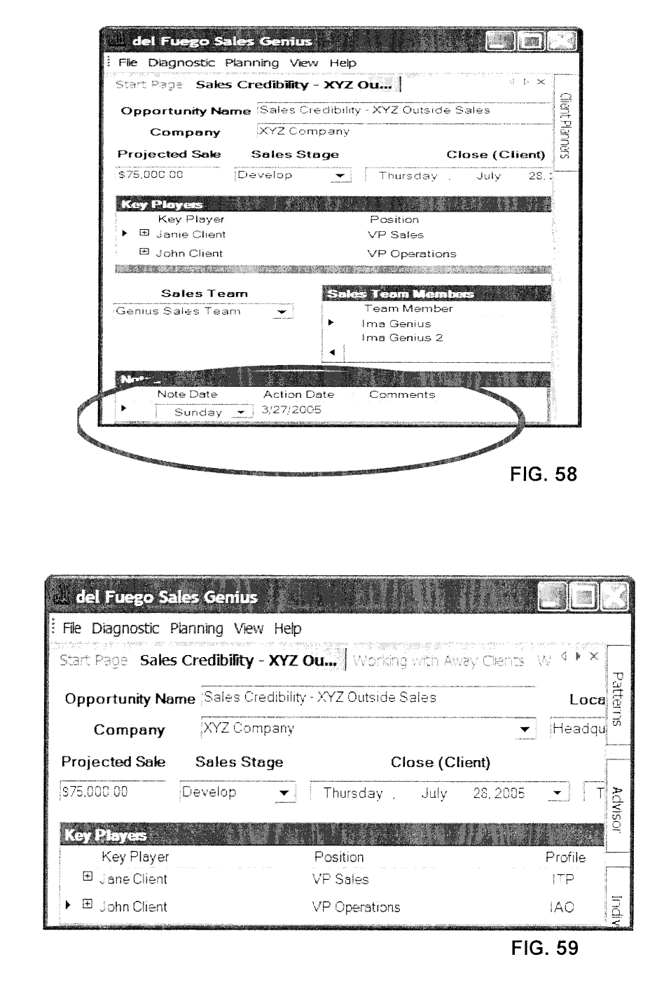

Referring to FIG. 58, the last section in the client planning and scheduling process receives notes a user may add regarding the account, the client, the sales team, which notes may affect the sale. To add a note, the user may right click in the Note Date box and select “Add a new note.” When the user clicks in the Note Date and Action Date boxes, the sales coaching system opens a calendar. Then, the user may select the appropriate date. Then, the user clicks in the comments box and the text editor appears at which point the user may enter a note and click OK to record the note.

Before the disclosed subject matter allows the user to move to the next step, the user may accelerate the goal-oriented communication or sales process and increase his credibility with the client. In the example of FIG. 59, a user may have been using the sales coaching system with Jane client and John client and may have noticed that their profiles or buying patterns are different with the exception that both are Internal. Jane is ITP and John is IAO. The user may compare the information entered into the interact, position and present boxes for Jane and John and then debrief the sales team on what the information could mean.

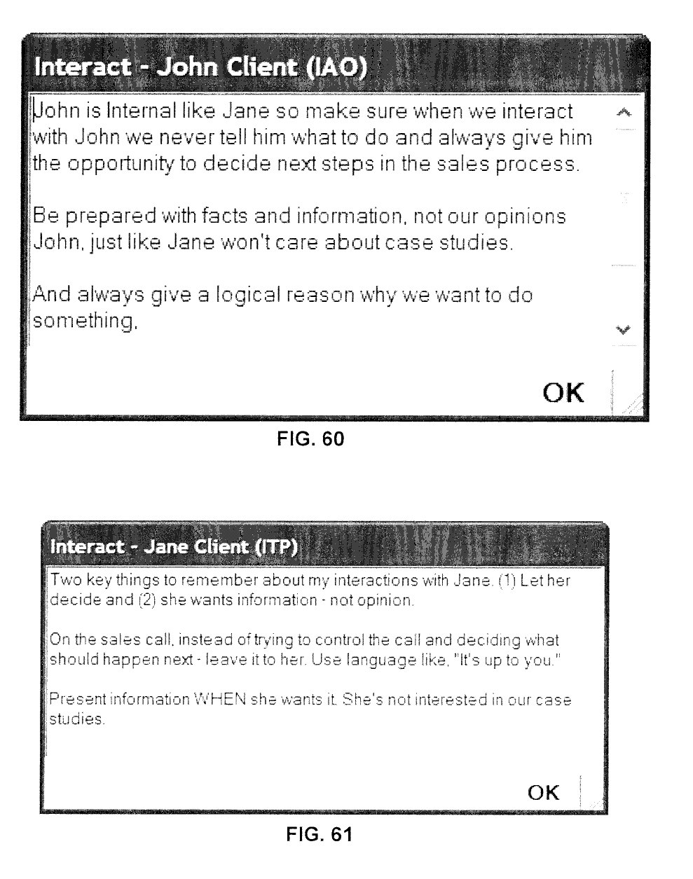

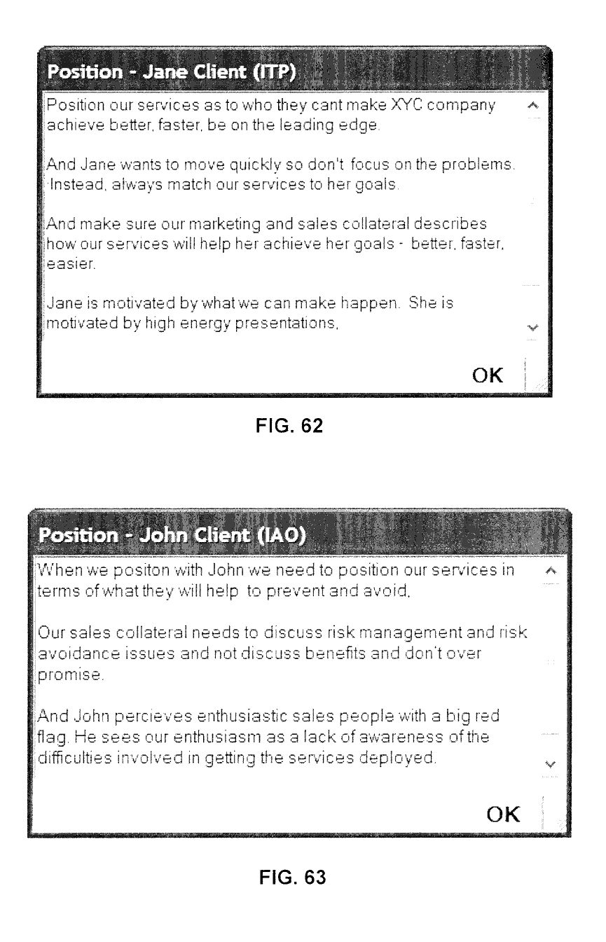

The information in the interact box for both Jane Client (FIG. 60) and John Client (FIG. 61) is similar because both are Internal. The information regarding how the sales person should position services based on John and Jane's Profile takes on the following aspects. In terms of positioning services, Jane Client (FIG. 62) is Toward and John Client (FIG. 63) is Away From. This has ramifications in terms of the goal-oriented communication or sales process.

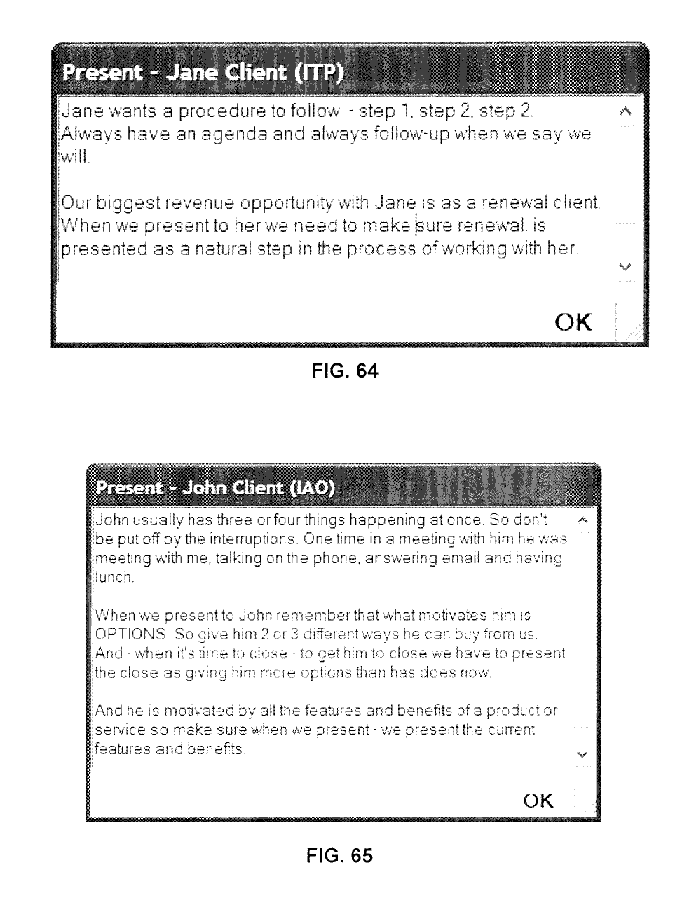

The user may see major differences between how the user would position a services with Jane vs. John. In terms of presenting services, Jane Client (FIG. 64) and John Client (FIG. 65) have different patterns. The user may also see major differences in how the user presents to key players.

The sales coaching system facilitates being specific in interacting, positioning and presenting. Learning to be specific in these three areas with each client and their buying patterns will mean that the user begins to speak “their” language for the sale. The user may also interact in ways that create credibility in the interaction. And, the user will be able to anticipate where challenges may arise and compensate for it. This is the advantage that the present embodiment and the principles it enables offer. Moreover, the user may sell successfully to individuals the user has never been able to sell to before.

For sales team assignments and company assignments, the sales coaching system gives the user a way to view and organize a sales teams and client companies. The user may identify, add, remove, update and delete sales teams and client companies.

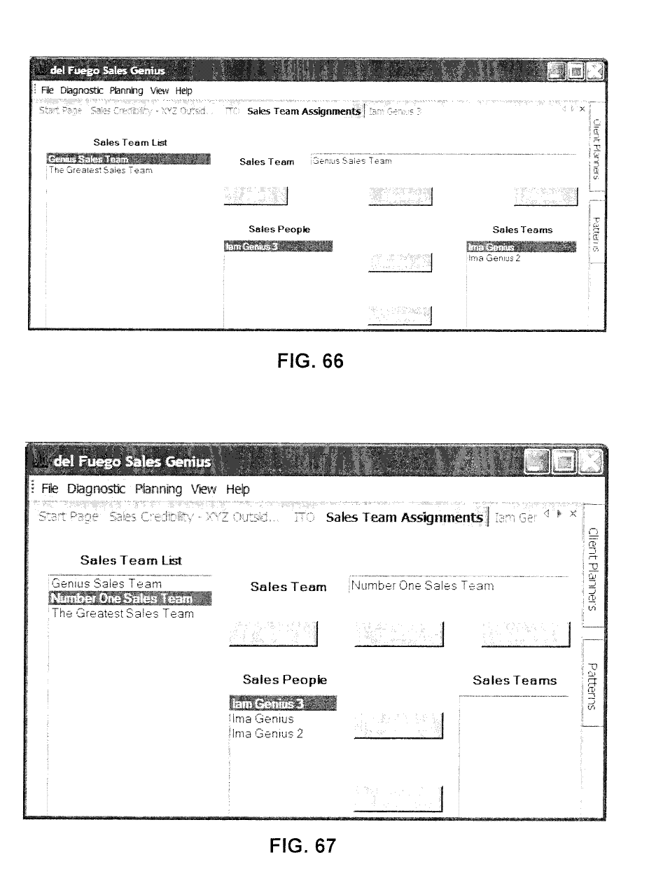

For sales team assignments, sales managers may make sales team assignments by selecting planning from the menu bar and then selecting sales team assignments. In FIG. 66, refer to the box on the left-hand side of the screen, sales team list. This box displays the names of the sales team or teams the user identifies when the user completes individual diagnostic processes. To display the names of the people assigned to a team, the user may click on the name of a team in the sales team list box. In the disclosed example, the “Genius” sales team has been selected and in the box directly to the right, sales team, the name of the sales team selected—“Genius” sales team—is displayed.

Referring to the sales team box in FIG. 66, the two sales people assigned to the “Genius” sales team are displayed, “Ima Genius” and “Ima Genius 2.” When the user select a sales team name, from the sales team list box, the names of the sales people assigned to that team are displayed in the sales teams box, as our example shows. Also notice that “Ima Genius 3” is in the sales people box. This box displays the individual sales people not assigned to the team the user has selected in the sales team list box. Note: “Ima Genius 3” has not been assigned to the team the sales coaching system has selected—“Genius” sales team.

The present embodiment also permits the user to organize sales teams. For adding a sales team, a user may take the following actions: (1) type in the name of the team the user wants to add in the sales team box at the top of the screen; and (2) click on the add button. The name of the sales team the user just added is now displayed in the sales team list box. The user may also add a new sales team while the user is completing the individual diagnostic process for a sales team member. Notice in FIG. 67 appears a screen shot of how the sales coaching system added the sales team—“Number One” sales team.

Also notice the sales people box now lists all the individual sales people that have been “diagnosed” in sales coaching system. All are listed because, at this point, none has been assigned to the sales team that is currently selected in the sales team list box.

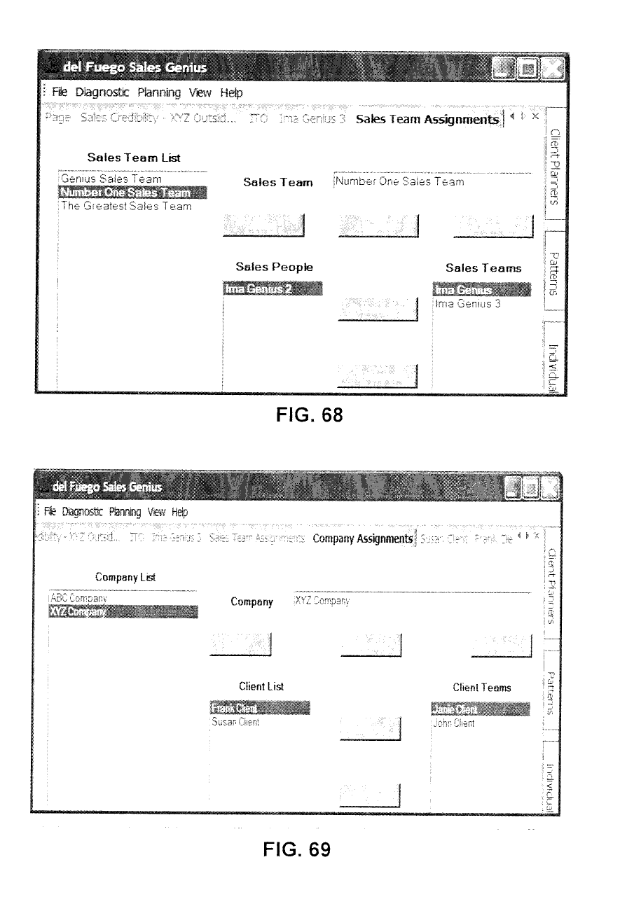

The user may also assign or remove members from a team. To do this, the user may (1) select the team name from the sales team list box, and (2) select the team member the user want to assign from the sales people box and click the assign button. Notice the name now appears in the sales team box. Alternatively, the user may select the team member and may wish to remove a team from the sales team box by clicking the remove button. In the example of FIG. 68, notice the present embodiment has assigned “Ima Genius” and “Ima Genius 3” to the “Number One” sales team.

The update function allows the user to rename a team. To do this, the user may (1) select the team from the sales team list whose name the user want to change, (2) from the sales team box, enter the new name, and (3) click update and the new name is now displayed in the sales team list box. Likewise, the user may delete the name of a sales team. When the user deletes a sales team, doing so does not delete the members because team names and team members are separate.

To delete the name of a sales team, the user may (1) select the name from the sales team list box, and (2) click on the delete button, on the right-hand side of the screen.

Company assignments work similar to sales team assignments. For this function, the user may select Planning from the menu bar and then select company assignments. In FIG. 69 appears a box on the left-hand side of the screen, company list. It displays the names of the companies the user has identified when the user completed client diagnostic processes.

When the user clicks on a company name in the company list box, the user sees the names of the individual clients the user has diagnosed and identified with that company in the client teams box. In our example, Jane client and John client are with “XYZ” company. In the client list box the user see the names of all the other individual clients who are in sales coaching system. The reason they are in the client list box and not client team's box is because they are not part of “XYZ” company. This feature makes it easy for the user to remember, at a glance, which clients are associated with which companies.

For adding a company, the user may (1) type in the name of the company the user wants to add in the company list box at the top of the screen at FIG. 70, and (2) click the add button. The name of the company the user just added will display in the company list box. In the example to the right, the user added “F&S LLC.” The user may also add a new company while completing the client diagnostic process.

The update function allows the user to rename a company. To do this, the user may (1) select the company from the company list box whose name the user want to change, and (2) enter the new name in the company box. Then, the user clicks the update button and the new name is now displayed in the company list box. Notice in the example of FIG. 71, the user updated the company name from F&S LLC, in the top example—to “F&SMN LLC.”

The user may delete the name of a company. To delete a company, the user may (1) select the company from the company list box; and (2) click on the Delete button on the right-hand side of the screen.

The user may also assign or remove clients from a company. To assign a client to a company, the user may (1) select the client the user want to assign from the client list box; and (2) click on the assign button. The reader should note that the name now appears in the client team box. To remove a client from a company, the user may (1) select the client the user wish to remove from client team box, and (2) click the remove button.

The processing features and functions described herein may be implemented in various manners. For example, the sales coaching systems may be implemented in an application specific integrated circuit (ASIC), a microcontroller, a microprocessor, or other electronic circuits designed to perform the functions described herein. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, any claimed subject matter is not intended to be limited to the embodiments shown herein but is to be accorded the widest scope consistent with the principles and novel features disclosed herein.

What is claimed is:

1. A method for implementing a goal oriented dialogue, the method comprising the steps of:
gathering and inputting data relating to a client's motivational characteristics;
analyzing and diagnosis client's motivational characteristic;
gathering and inputting data relating to a sales representative motivational characteristic;
analyzing and diagnosis sales representative motivational characteristic
combining diagnosed client's and sales representative motivational characteristic;
generating a goal-oriented sales strategy based on combined diagnosis; and
implementing the generated strategy by the sales representative.

2. The method of claim 1 further including the step of generating a script for interaction with the client.

3. The method of claim 2, wherein the generated script comprises at least one of an Interact, Position and Present script tailored to the client's motivational characteristic.

4. The method of claim 1, wherein the client's gathered data is inputted via a series of true/false formatted questions.

5. The method of claim 1, wherein the sales representative's gathered data is inputted via a series of true/false formatted questions.

6. The method of claim 1, wherein a component of the diagnosed client's motivational characteristic comprises one of an Internal and External characteristic.

7. The method of claim 1, wherein a component of the diagnosed client's motivational characteristic comprises one of a Towards and Away From characteristic.

8. The method of claim 1, wherein a component of the diagnosed client's motivational characteristic comprises one of a Procedural and Options characteristic.

9. The method of claim 6, wherein a second component of the diagnosed client's motivational characteristic comprises one of a Towards and Away From characteristic.

10. The method of claim 9, wherein a third component of the diagnosed client's motivational characteristic comprises one of a Procedural and Options characteristic.

11. The method of claim 10, further including the step of generating a script for interaction with the client.

12. The method of claim 11, wherein the generated script comprises at least one of an Interact, Position and Present script tailored to the client's motivational characteristic.

13. A software product capable of instructing a computer system on a computer readable medium, wherein the software product comprises:
an instruction to retrieve and process data relating to a client's motivation characteristic;
an instruction to analyze and determine a client's motivation characteristic;
an instruction to retrieve and process data relating to a sales representative motivation characteristic;
an instruction to analyze and determine a sales representative motivation characteristic;
an instruction to combine generated client's and sales representative's motivation characteristic; and
an instruction to produce a goal-oriented sales strategy based on the combined motivation characteristic of the client and the sales representative.

14. The computer-accessible medium of claim 13, wherein the medium further comprises:
an instruction to generate a script for interaction with the client.

15. The computer-accessible medium of claim 13, wherein the generated script comprises at least one of an Interact, Position and Present script tailored to the client's motivational characteristic.

16. The computer-accessible medium of claim 13, wherein the client's retrieved data is generated via a series of true/false formatted questions.

17. The computer-accessible medium of claim 13, wherein the sales representative's retrieved data is generated via a series of true/false formatted questions.

18. The computer-accessible medium of claim 13, wherein a component of the produced client's motivational characteristic comprises one of an Internal and External characteristic.

19. The computer-accessible medium of claim 18, wherein a component of the produced client's motivational characteristic comprises one of a Towards and Away From characteristic.

20. The computer-accessible medium of claim 19, wherein a component of the produced client's motivational characteristic comprises one of a Procedural and Options characteristic.

21. The computer-accessible medium of claim 20, wherein the generated script comprises at least one of an Interact, Position and Present script tailored to the client's motivational characteristic.

21. The computer-accessible medium of claim 14, wherein the generated script comprises at least one of an Interact, Position and Present script tailored to the client's motivational characteristic.
